(19) United States
(12) Patent Application Publication
(10) Pub. No.: US 2010/0064297 A1
(43) Pub. Date: Mar. 11, 2010

(54) Configuring And Providing Enhanced Access To Profibus Device Diagnostic Data

(75) Inventors: Benno Doll, Fellbach (DE); Johan Ingemar Tegnell, Mansfield, MA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 12/237,975

(22) Filed: Sep. 25, 2008

Related U.S. Application Data
(60) Provisional application No. 61/094,804, filed on Sep. 5, 2008.

(51) Int. Cl. G06F 9/54

(52) U.S. Cl. 719/315

(57) ABSTRACT

A method and system are disclosed for providing enhanced user access to Profibus device diagnostic data and cyclic data in a distributed control system. After receiving input parameter data originating from a Profibus device message, the I/O module assembly performs steps for processing, maintaining and providing the input parameter data to a requesting control processor. The processing step includes extracting parameter values from a received Profibus device message. The extracted parameter values are then deposited in a repository on the I/O module assembly. The parameter values include both input and diagnostic parameter values. The diagnostic parameter values are provided to a workstation executing a Profibus device commissioning/configuring application in the form of data bits. The application generates a set of diagnostic text messages, based upon current values of diagnostic data bits representing diagnostic statuses of the Profibus device, by applying a configurable set of diagnostic message definitions to the diagnostic parameter data bits.

### CROSS-REFERENCE TO RELATED APPLICATION

This application claims the priority benefit of Doll et al., U.S. Provisional Patent Application Ser. No. 61/094,804, filed on Sep. 5, 2008, entitled “Configuring And Providing Enhanced Access To Profibus Device Diagnostic Data,” the contents of which is incorporated herein by reference in its entirety, including any references therein.

### FIELD OF THE INVENTION

This invention relates generally to networked computerized industrial process control systems and, more particularly, relates to utilities providing lifetime support of field devices such as transmitters, positioners, etc. Tasks associated with such lifetime support include configuring, commissioning, monitoring, maintaining and replacing the field devices within an industrial process control system environment including potentially many types of field device types. More particularly, the present invention relates to a process control network, such as a Profibus network, wherein information relating to a set of field devices is acquired and concentrated in a single bus master that, in turn, provides corresponding information to a variety of supervisory/control nodes.

### BACKGROUND

Industry increasingly depends upon highly automated data acquisition and control systems to ensure that industrial processes are run efficiently, safely and reliably while lowering their overall production costs. Data acquisition begins when a number of sensors measure aspects of an industrial process and periodically report their measurements back to data collection and/or control systems. Such measurements come in a wide variety of forms and are used by industrial process control systems to regulate a variety of operations, both with respect to continuous and discrete manufacturing processes. By way of example the measurements produced by a sensor/recorder include: a temperature, a pressure, a pH, a mass/volume flow of material, a quantity of bottles filled per hour, a tallied inventory of packages waiting in a shipping line, or a photograph of a room in a factory. Often sophisticated process management and control software examines the incoming data, produces status reports, and, in many cases, responds by sending commands to actuators/controllers that adjust the operation of at least a portion of the industrial process. The data produced by the sensors also allow an operator to perform a number of supervisory tasks including: tailor the process (e.g., specify new set points) in response to varying external conditions (including costs of raw materials), detect an inefficient/non-optimal operating condition and/or impending equipment failure, and take remedial actions such as adjust a valve position, or even move equipment into and out of service as required.

Typical industrial processes today are extremely complex and comprise many intelligent devices such as transmitters, positioners, motor drives, limit switches and other communication enabled devices. By way of example, it is not unheard of to have thousands of sensors and control elements (e.g., valve actuators) monitoring/controlling aspects of a multi-stage process within an industrial plant. As field devices have become more advanced over time, the process of setting up field devices for use in particular installations has also increased in complexity.

In previous generations of industrial process control equipment, and more particularly field devices, transmitters and positioners were comparatively simple components. Before the introduction of digital (intelligent) transmitters, setup activities associated with a field device were relatively simple. Industry standards like 3-15 psi for pneumatic instruments or 4-20 ma for electronic instruments allowed a degree of interoperability that minimized setup and configuration of analog transmitters.

More contemporary field devices include digital data transmitting capabilities and on-device digital processors, referred to generally as “intelligent” field devices. Such devices generally support an extensive set of parameters for providing a variety of status, diagnostic and process variable values.

One particular class of intelligent field device incorporates the Profibus protocol/architecture. In process control systems that embody the Profibus protocol, an example of a Profibus device hardware configuration includes a device I/O module and a set of field I/O cards that connect the Profibus device I/O module to a set of field devices. The device I/O module receives data from the set of field I/O cards and merges the received data into a single message string. The single message string is transmitted by the device I/O module of the Profibus device to an I/O module assembly (e.g., an Invensys FBM222).

In the known Profibus systems, the I/O module assembly receives messages from Profibus devices wherein each received message contains the combined data for all signals provided by the field I/O cards installed on a corresponding Profibus device rack. Known I/O module assemblies are programmed to provide the received messages in their unprocessed form to requesting entities such as control processors and system management applications/interfaces. In the known systems, a control processor, configured to execute a set of distributed control interface (DCI) blocks, submits requests for particular individual pieces of information in association with the execution of the DCI blocks. The requests from the control processors pertain to individual pieces of information contained within Profibus messages rather than groups of information provided within Profibus messages. Therefore, a separate request is submitted by a control processor to an I/O module assembly for each piece of information that is read or written.

Profibus device messages potentially carry a variety of information. In addition to providing process variable measurement values, the message data potentially includes a variety of diagnostic and status information provided in the form of data bits. In some instances each bit of diagnostic and/or status information is pre-configured to have a particular meaning. Known I/O module assemblies are capable of extracting and forwarding the contents of the received messages, including the status bits, to control processors (in response to the aforementioned DCI block-initiated requests). In some known systems, each status bit is associated with an LED on a Profibus device LED panel, the meaning of which is determined by consulting a user guide associated with the LED panel of the customized Profibus device.

### SUMMARY OF THE INVENTION

A method and system are presented herein for managing Profibus device information in a distributed control system. In such system, a Profibus device is communicatively coupled via a network link to an I/O module assembly (e.g., a field bus module), and the I/O module assembly receives Profibus device messages from the Profibus device containing information relating to connected device modules. The I/O module assembly includes one or more tasks for extracting data bits contained within the received Profibus device messages according to a Profibus device configuration.

In view of the challenges and complexities of providing human-readable messages associated with various diagnostic states, a highly configurable executable I/O module and a configuration tool for customizing the executable I/O module are provided. A configuration tool facilitates creating a set of customized, application-specific templates for modules to interpret one or more diagnostic data bits from a received Profibus device composite message, and then derive advanced diagnostic information from the extracted diagnostic data bits. The derived advanced diagnostic information is presented in the form of text descriptions via a user interface of a monitor application executed on a workstation computer.

Similarly, a method and system are disclosed for providing enhanced user access to Profibus device diagnostic data in a distributed control system in accordance with the aforementioned advanced diagnostics information presentation configurations. After receiving input parameter data originating from a Profibus device message, the I/O module performs steps for processing, maintaining and providing parameter value data to a requesting control processor. The processing step includes extracting parameter values from a received Profibus device message. The extracted parameter values are then deposited in a repository on the I/O module assembly. The parameter values include diagnostic parameter values. The diagnostic parameter values are provided to a workstation executing a Profibus device commissioning/configuring application in the form of data bits. The application generates a set of diagnostic text messages, based upon current values of diagnostic data bits representing diagnostic statuses of the Profibus device, by applying a configurable set of diagnostic message definitions to the diagnostic parameter data bits.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is schematic diagram depicting an exemplary process control network environment wherein the present invention is potentially incorporated;

FIG. 2 schematically depicts a set of entities, and their corresponding interfaces, associated with an exemplary system;

FIG. 3 schematically depicts a set of components associated with configuration of a Profibus I/O module assembly;

FIG. 4 identifies a set of fields that comprise a portion of a configuration file for an I/O module assembly coupled to a set of Profibus devices;

FIG. 5 illustratively depicts an exemplary graphical user interface for specifying I/O module bus parameters and I/O module configuration data;

FIG. 6 depicts an exemplary user interface for specifying Profibus device bus parameters;

FIG. 7 depicts an exemplary graphical user interface for configuring a set of modules associated with a Profibus device;

FIG. 8 depicts an exemplary graphical user interface for displaying user parameters (name and current value) of a selected module;

FIG. 9 depicts an exemplary user interface for defining cyclic input parameters for a Profibus device;

FIG. 10 depicts an exemplary complete set of fields for the Input Parameters grid along with an exemplary set of input parameter entries;

FIG. 11 depicts an exemplary user interface for defining cyclic output parameters for a Profibus device;

FIG. 12 depicts an exemplary complete set of fields for the Output Parameters grid along with an exemplary output parameter entry;

FIG. 13 is a flowchart summarizing an exemplary set of steps for defining the Input and Output parameters of a Profibus device;

FIG. 14 is an exemplary user interface for creating connections between DCI blocks and corresponding Profibus input/output parameters;

FIG. 15 is a flowchart summarizing a set of steps for providing an input parameter with an associated status parameter;

FIG. 16 depicts an exemplary user interface for defining Diagnostics (data and messages) for a Profibus device;

FIG. 17 depicts an exemplary complete set of fields for the Diagnostic Messages grid along with an exemplary set of Diagnostic Message entries;

FIG. 18 depicts an exemplary diagnostics tab control for a user interface application for creating and displaying diagnostic messages from diagnostic data bits provided by a Profibus device;

FIG. 19 is a flowchart summarizing an exemplary set of steps for defining and thereafter saving diagnostic messages for a Profibus device template;

FIG. 20 is a flowchart summarizing a set of steps performed during the runtime use of diagnostic messages contained in deployed Profibus device configurations (based on previously defined Profibus device configuration templates); and

FIG. 21 depicts an exemplary cyclic input data tab control for a user interface for displaying cyclic data interpreted as input parameters.

### DETAILED DESCRIPTION OF THE DRAWINGS

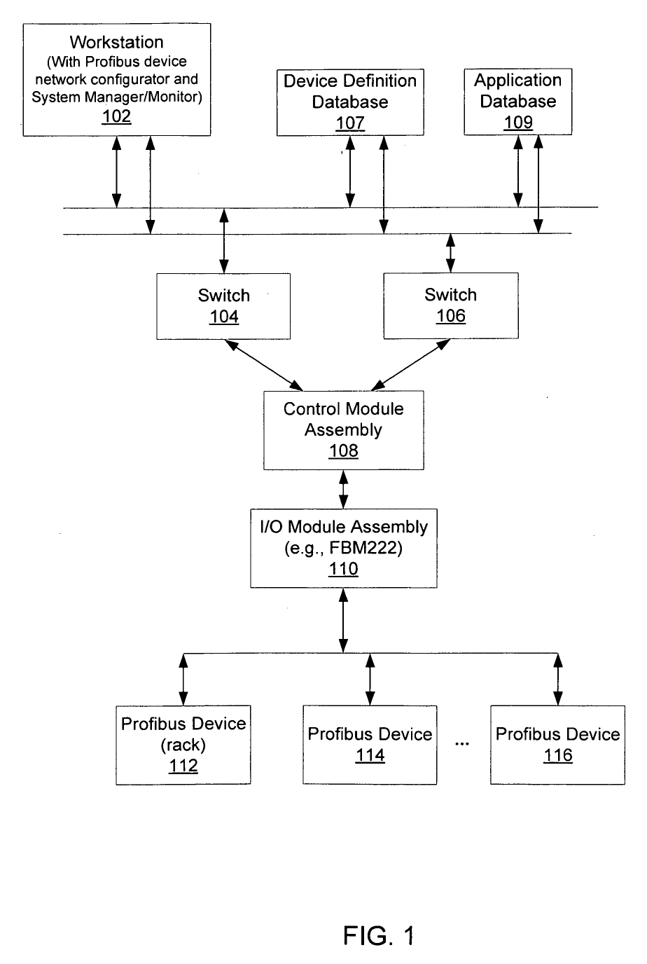

Turning to FIG. 1, an exemplary simple industrial process control system arrangement/environment is depicted. A workstation 102, comprising a variety of system configuration and monitoring applications, provides an operator/engineering interface through which an engineer/technician configures and thereafter potentially monitors the components of an industrial process control system including a Profibus device network. The workstation 102 comprises any of a variety of hardware/operating system platforms. By way of example, the workstation 102 comprises a personal computer running on the MICROSOFT WINDOWS operating system. However, alternative embodiments of the invention can potentially run on any one or more of a variety of operating systems such as: Unix, Linux, Solaris, Mac OS-X, etc.

In accordance with an exemplary embodiment, the workstation 102 hosts a Profibus device network configuration application and a System manager/monitor application. The configuration application provides access to a database (device definition database 107) for persistent storage of previously defined descriptions of configurable tasks executable by Profibus device I/O module assemblies. The Profibus device I/O module assemblies are customized via the descriptions rendered by the configuration application and then subsequently downloaded to the I/O module assemblies such as I/O module assembly 110. Access is also provided to an application database 109 that stores a set of customization definitions that were previously downloaded to I/O module assemblies.

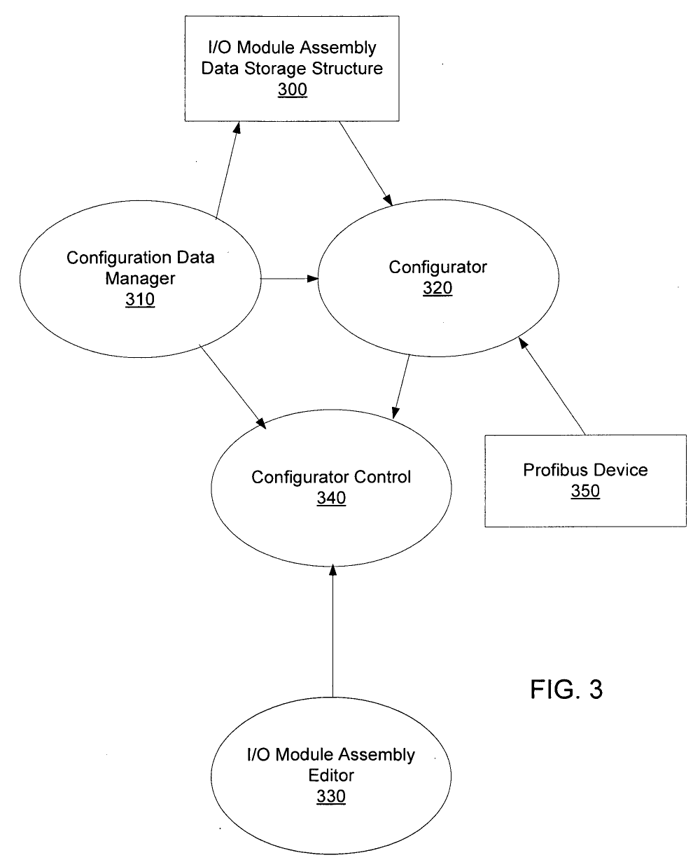

The configuration application provides access to a set of templates for specifying customizable tasks executed by the I/O module assembly 110 (e.g., an INVENSYS's field bus module model FBM222). The interfaces and components associated with configuring the downloadable modules of the I/O module assembly 110 are described further herein below with reference to FIG. 3.

The configuration application also enables users to define tasks, executed for example on the workstation 102, for processing diagnostic data bits contained within a composite message received from a Profibus device and providing enhanced diagnostic information derived from the diagnostic data bits contained within the composite message.

In the illustrative example, the workstation 102, device definition database 107 and application database 109 are connected in a redundant configuration via dual Ethernet interfaces/wiring to redundant switches 104 and 106. The Ethernet switches 104 and 106 are commercially available and provided, for example, by Allied Telesyn (e.g., model AT-8088/MT). While not specifically depicted in FIG. 1, additional nodes, comprising workstations, servers and other elements (e.g., control module assemblies) of a supervisory portion of the process control system are potentially connected to the redundant switches 104 and 106. In the illustrated embodiment, a device definition database 107 and application database 109 store information regarding I/O module assembly module types (templates) and module instances, respectively. Furthermore, while hardwired connections between the workstation and switches 104 and 106 via ETHERNET local area network links are depicted in FIG. 1, such links over a local supervisory level process control network are alternatively carried out via wireless network interfaces.

The switches 104 and 106 (as well as potentially other non-depicted switches) are also communicatively coupled to a control module assembly 108. The control module assembly 108 comprises one or more control modules (also referred to as control processors). An illustrative example of such control module assembly 108 is a Foxboro CP model FCP270, by Invensys Systems, Inc. In other embodiments, process control functionality is carried out in any of a variety of control modules—even by control programs incorporated into the workstations, intelligent transmitters, or virtually any communicatively coupled device capable of executing control programs, loops, scripts, etc.

With continued reference to FIG. 1, the I/O module assembly 110, alternatively referred to as a field bus module, is connected to the control module assembly 108. The communications protocol utilized for carrying out communications between the I/O module assembly 110 and control module assembly 108 is potentially any one of a variety of proprietary/non-proprietary communications protocols. In one embodiment, the communications between the control module assembly 108 and I/O module assembly 110 are carried out via a 2 MBit HDLC communication bus. While only a single I/O module assembly 110 is depicted in the illustrative example, embodiments of the invention comprise many I/O module assemblies.

The I/O module assemblies, in general, include a variety of interfaces for communicating directly and/or indirectly to a variety of devices including, for example, Profibus devices. In the illustrative example, the I/O module assembly 110 comprises a Profibus I/O module assembly (e.g., an INVENSYS's field bus module model FBM222) that supports communications between the control module assembly 108 and a set of Profibus devices 112, 114, and 116. In the illustrative embodiment, the set of representative Profibus devices 112, 114 and 116 comprise racks containing multiple device protocol-specific cards. The Profibus devices 112, 114 and 116 communicate with a variety of field devices that operate at the lowest level of an industrial process control system to measure (transmitters) and control (positioners) plant activity.

In the exemplary embodiment, each Profibus device 112, 114, and 116 accumulates a set of values associated with the field device. The set of values are packaged in a single message containing a string of data/status bits. The single message is thereafter sent by each of the devices 112, 114 and 116 to the I/O module Assembly 110 (e.g., FBM222) for further processing. The I/O module assembly 110, after initially storing the received message in local memory, performs a variety of programmed and asynchronous tasks in response to requests from the control module assembly 108. In an exemplary embodiment, the I/O module assembly 110 responds to asynchronous requests from the control module assembly 110 (e.g., DCI block commands) to provide information relating to particular bits of data from the received/stored messages received by the assembly 110 from the Profibus devices 112, 114, and 116. In addition, the I/O Module Assembly 110 is capable of sending messages, comprising commands and data, to each of the Profibus devices 112, 114, and 116.

In accordance with illustrative examples, configurable tasks are supported for processing diagnostic data bits extracted from a Profibus message package. For example, a configurable diagnostic task executed on the workstation 102 interprets particular information bits within a Profibus message indicative of an observed diagnostic status. After extracting the information provided by a status bit (or combination of bits), the configurable task provides a previously configured text message that is displayed for a user of the workstation 102.

Furthermore, each diagnostic bit (or set of bits) is potentially linked to additional text describing a category (e.g., identifying an error type) and an action to be taken by a human observer/technician in view of a described error status. The above-described additional pieces of information applied to status bits are exemplary. The above-described supplemental information and other configurable information, potentially assignable to particular status bits of a Profibus message, are described further herein below.

In accordance with another aspect of the exemplary embodiment, the configuration application for specifying the aforementioned supplementary status bit information (e.g., a text error message) for Profibus messages supports a template library wherein a set of child (grandchild, etc.) templates are defined from one or more base Profibus message configuration templates. Once defined, the templates' relationships are retained and visually displayed in the form of a collapsible/expandable hierarchical tree within a graphical user interface supported by the configuration application.

At runtime the configured tasks of the I/O module assembly 110 perform a variety of operations locally to acquire and process Profibus messages for use by process status control and monitoring applications. In accordance with an aspect of the I/O module assembly 110's runtime behavior, two distinct pieces of information, representing a primary value parameter (e.g., a measured/sensed quantity) and a status parameter quality (e.g. a status byte representing a set of test results rendered in the field for data quality), are processed locally on the I/O module assembly 110. The I/O module assembly 110, is thus capable of rendering a primary value parameter and an associated status quality (good/bad) for the primary value parameter as a single unit of response information in response to a single request from the control module assembly 108 (e.g., the request for the primary value of a parameter). Thus, for example, in addition to providing a sensor reading, the I/O module assembly 110, in response to a single request from the control module assembly 108, provides a related status of the primary value (good/bad) based upon an associated status parameter that was processed locally according to a pre-configured status criterion (e.g., a status mask).

Also, at runtime, in an exemplary embodiment the workstation 102 executes a set of previously configured tasks defined by computer-executable instruction stored on a physical computer-readable medium. The configured tasks extract particular diagnostic data bits and provide one or more pre-configured supplementary data pieces (e.g., text strings) associated with the particular status bits.

The process control network schematically depicted in FIG. 1 is greatly simplified for purposes of illustration. Those skilled in the art will readily appreciate that both the number of components, at each depicted level of the exemplary process control system, is generally many times greater than the number of depicted components. This is especially the case with regard to the number of depicted field devices. In an actual process control environment, the number of field devices, comprising both input devices (e.g., transmitters) and output devices (e.g., positioners) number in the hundreds for an industrial process control system.

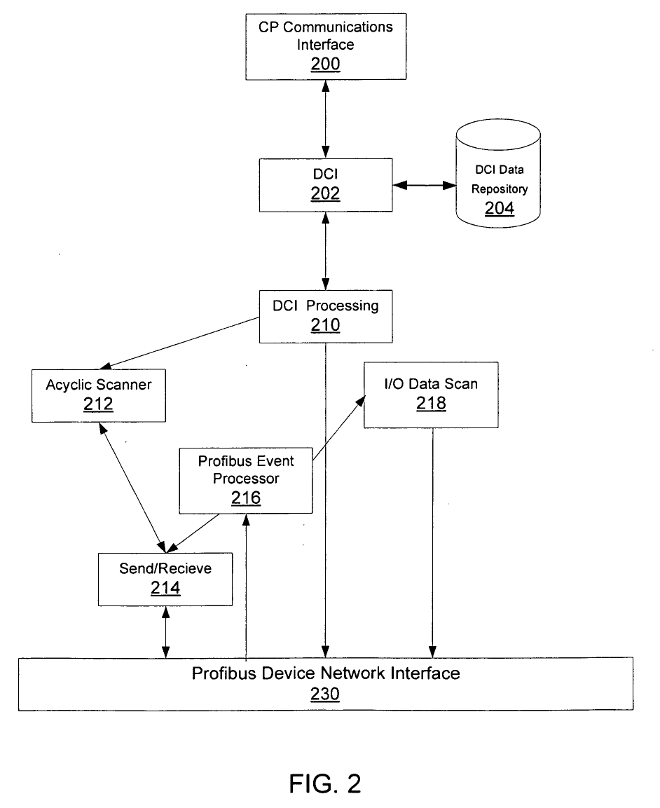

Turning to FIG. 2, a block diagram illustratively depicts functional components of an exemplary embodiment (an FBM222) of the I/O module assembly 110 for carrying out a variety of configurable tasks on behalf of control processors and other higher level control/monitor components. A set of modules (identified herein by their associated “tasks”) executed within the I/O module assembly 110 are identified in FIG. 2 that facilitate receiving and processing Profibus device messages, and responding to DCI block-initiated requests from the control module assembly 108. In the exemplary embodiment, these modules cooperatively operate to implement an analytical/processing layer on top of a Profibus message communication layer that facilitates: extracting particular pieces of information from a received Profibus device message, processing particular pieces of information contained within the received Profibus device message according to previously specified configuration information (e.g., providing a data point status value with a requested data point value ), and carrying out operations within the I/O module assembly 110 in response to a single received DCI calls that would otherwise need to be performed through multiple DCI calls from the control module assembly 108. The set of modules/tasks are described herein below with reference to FIG. 2.

In the exemplary embodiment, the I/O module assembly 110 communicates with the control module assembly 108 via a multi-layered control processor communications interface 200 including an HDLC (e.g., RS485) controller/protocol handler, a process I/O protocol handler, and a DCI protocol handler (for extracting and forwarding DCI calls from received messages).

A DCI task 202 module exposes an extensive set of externally callable functions for handling (responding to) DCI calls (messages) from the communications interface 200 DCI protocol handler and managing a DCI data repository 204. The callable functions support updating the content (e.g., fields) of the DCI data repository 204 that contains both configuration (connections) and runtime information relating to connectable Profibus devices and providing responses to DCI calls issued by the control module assembly 108. Other callable functions exposed by the DCI task 202 module relate to the general operation of the DCI task 202. Such general operation functions of the DCI task 202 support initializing, starting, and posting data to the DCI task 202. In an exemplary embodiment, at startup the DCI task 202 initializes access to the repository 204 and pre-builds DCI response messages. A DCI message processing function is exposed by the DCI task 202 module for invoking the processing of a DCI message passed by the DCI protocol handler of the interface 200 to the DCI task 202.

A set of functions exposed by the DCI task 202 supports accessing configuration and runtime data maintained within the DCI data repository 204. The set of functions facilitate storing Profibus device data configurations (described herein below) and runtime data associated with connectable Profibus devices. Moreover, the DCI task 202 maintains pre-built responses in the DCI data repository 204 to expedite responding to DCI requests from the control module assembly 108. Furthermore, data integrity is maintained in the repository 204 by implementing locking mechanisms.

Exemplary types of data accessed in the repository 204 via the exposed data repository access functions (e.g., “get”, “set”, “scan”, etc.) include: I/O module assembly control/status fields, Profibus device configuration/control/status fields, and point/IOdata configuration/data fields. The I/O module assembly control fields include parameters specifying on/off line status, link status, enabling alarms, and enabling messages. The Profibus device control fields include parameters specifying: connections (e.g., handle, data size and data value), type/version, error options, diagnostics statuses, alarms, enabled/disabled status, handle, link, address, device status, file data (typically from a workstation), I/O data (Profibus device message string), configuration data (describing content of the I/O data), number of points, and point handles. The point/data connection parameters within the repository 204 accessed via the DCI task 202's interface functions include: name, I/O data, data type, connection type, configuration options, configuration data, initial value, update period, point data, connection status, registered write function (called when data is written to the I/O module assembly 110 by the control module assembly 108), link number (for a particular point), handle, and parent handle.

In accordance with particular aspects of an illustrative embodiment, the DCI task 202 cooperatively operates with a set of event processing and Profibus device data I/O tasks (implemented by corresponding modules) to carry out enhanced functionality within the I/O module assembly 110. In the absence of the enhanced functionality, completing the same functions would otherwise require multiple transactions between the I/O module assembly 110 and the control module assembly 108. Such tasks include: a DCI processing task 210, an acyclic data scanner task 212, a send/receive task 214, a Profibus event processor task 216, and an I/O data scan task 218. These tasks are described herein below with continued reference to FIG. 2.

The acyclic data scanner task 212 module supports scheduling and executing updates to acyclic data points (e.g., DCI points that utilize DP V1 acyclic services). The acyclic data scanner task 212 maintains a scan list of acyclic transactions. Each entry in the list corresponds to a configured DCI block. The acyclic data scanner task 212 periodically accesses device-specific parameters containing process data or device diagnostic data corresponding to the configured DCI blocks. The acyclic data scanner task 212 exposes a set of functions for posting, with regard to a acyclical data services: a stack response message, a scan list change message, and a port enable/disable message. The acyclic data scanner task 212 receives messages from the DCI processing task 210 to build and modify the scan list. In an exemplary embodiment, all pending requests are combined into one transaction request and forwarded to the send/receive task 214 for further processing. Thereafter, a response message received from send/receive task 214 is decoded and each response is processed individually. The decoded received data is converted to DCI data, and the DCI data is stored in the DCI data repository 204.

The DCI processing task 210 module supports processing DCI requests originating, for example, from the control module assemble 108 and forwarded by the DCI task 202. The DCI processing task 210 supports DCI block processing by maintaining DCI connections on device and DCI block data levels. The DCI processing task 210 sends messages to the acyclic data scanner task 212 and the I/O data scan task 218 to update scan lists maintained by each. The DCI processing task 210 exposes a set of functions for setting the current state of a communications stack within the Profibus device network interface 230 and for posting a request message to a request queue for the acyclic data scanner task 212. The DCI processing task 210 stores device and data status information in the DCI data repository 204 according to configured connections between DCI blocks and Profibus Device data definitions.

The Profibus event processor task 216 module processes events generated by a Profibus device and received by the I/O module 110. The Profibus event processor task 216 exposes a function for initializing a set of events upon which the event processor task 216 blocks while waiting for the event to fire. A further function starts an event processor task for each connected Profibus device. The Profibus event processor task 216 maintains a local data structure for each currently active event.

The event processor task 216 blocks while waiting for notification of particular events from the Profibus device network interface 230. Upon receiving notification of an event, the event processor task 216 processes the received event notification and the processed event is forwarded to a proper event notification destination (e.g., the DCI processing task 210, the send/receive task 214, the I/O data scan task 218, etc.).

The Profibus event processor 216 facilitates providing expedited responses to events signaled by the Profibus device network interface 230. After a particular event is received and acknowledged by the event processor task 216, based upon a particular configuration for the event, a message to a lower priority task is posted (if needed/directed) for further processing. For example, a value in the repository 204 associated with the event is potentially set to notify the control module assembly 108 of the event.

A send/receive task 214 module interfaces with a Profibus protocol stack for a physical Profibus network interface to implement the acyclic transfer of information, via the Profibus device network interface 230, between the I/O module assembly 110 and connected Profibus devices. The send/receive task 214 is a central point of communication with Profibus communication stacks supported by the I/O module assembly 110. The send/receive task 214 processes requests in the order they are received, one by one. All outstanding requests are stored, for example, in a FIFO queue. The send/receive task 214 manages service requests to the Profibus device network interface 230. The send/receive task 214 module receives pre-built request transactions from the acyclic data scanner task 212, sends the request transactions to the Profibus device network interface 230, handles corresponding responses from the network interface 230 and redirects a final response back to an source of the request transaction. The requests are initially posted to a processing queue and then processed on a FIFO basis.

The send/receive task 214 module exposes a set of functions for starting a send/receive operation, posting a new request transaction to the processing queue, posting a stack immediate response message to the processing queue, and posting a stack remote response message to the processing queue. The send/receive task 214 receives requests from the acyclic data scanner task 212 and, in response, submits an acyclic read data request to the Profibus device network interface 230. The send/receive task 214 module receives request result notifications from the Profibus event processor task 216 and, in response, accesses the network interface 230 to obtain the response message data. The send/receive task 214 module posts a message to the acyclic data scanner task 212 containing response data.

The I/O data scan task 218 module supports updates to cyclic data. The I/O data scan task 218 maintains a local version of the cyclic scan list for the I/O module assembly 110 to read I/O data from Profibus devices, convert the received data into DCI format, and update the DCI data repository 204. The I/O data scan task 218 exposes functions for initializing and starting I/O data acquisition tasks and depositing I/O data into an I/O data processing queue. In an exemplary embodiment, events from a Profibus communication stack in the Profibus device network interface 230 signal the completion of each update cycle, and in response the I/O data scan task 218 updates DCI connection records in the DCI data repository 204. For Profibus devices with a defined input status value parameter, the I/O data scan task 218 evaluates the associated status parameter byte for an input primary value parameter and updates a corresponding DCI block data item (e.g., a good/bad status).

Having described the runtime operation of the I/O module assembly 110, attention is directed to configuration of the assembly 110. Initially, attention is directed to an exemplary arrangement for configuration of the I/O module assembly 110 depicted in FIG. 3. In the exemplary embodiment, an I/O module assembly data storage structure 300, containing a set of configuration settings for the I/O module assembly 110, is created during a configuration session. The storage structure 300 receives a configuration byte stream for the I/O module assembly 110 from a configuration data manager 310 based upon on a set of current configuration settings. A configurator 320 validates the set of current configuration settings of the storage structure 300.

An I/O module assembly editor 330 provides a user interface for configuring the I/O module assembly data storage structure 300. The editor 330 integrates a configurator control component 340 for configuration of bus parameters and settings.

A Profibus device 350 is a data storage structure corresponding to a Profibus device connectable to the I/O module assembly 110. In an exemplary embodiment, the configurator 320 uses the configurations of all Profibus devices assigned to the I/O module assembly 110 (represented in structure 300) for validation.

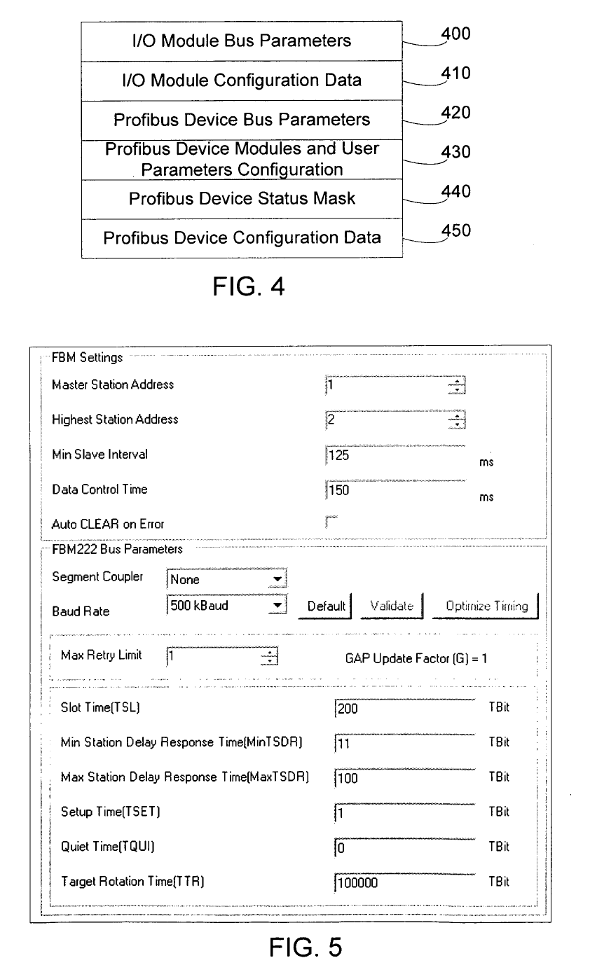

Turning to FIG. 4, a set of configuration definition groups are identified that comprise a portion of a configuration file for the I/O module assembly 110 coupled to a set of Profibus devices. I/O module bus parameters 400 provide a set of configurable properties defining a communications connection between the I/O module assembly 110 and the connected Profibus devices 112, 114, and 116. I/O module configuration data 410 comprises a set of fields specified via the configuration data manager 310 that define the general operation of the I/O module assembly 110. The I/O module configuration data 410 includes a file name identifying a configuration file.

Turning briefly to FIG. 5, an exemplary graphical user interface is depicted for specifying the I/O module bus parameters 400 and the I/O module configuration data 410. In the exemplary embodiment, the I/O module assembly is identified as FBM222 (a Profibus field bus module). In the illustrative example, a set of fields are provided for configuring the FBM 222 ports, settings and bus parameters.

The top portion of the exemplary configuration interface depicted in FIG. 5 is associated with “FBM Settings”. The set of configurable FBM settings includes: a master station address (assigned to the I/O module assembly 110). A highest station address corresponds to the highest address assigned to a connected Profibus Master station on the same Profibus network. The I/O module assembly 10 using the described configuration data will look for the other Master on a Profibus network from address 0 up to the HSA. An Auto clear on Error flag field enables a user to set an Auto Clear on Error flag. The flag is evaluated in Operate and Clear operation modes. If data transfer to at least one activated slave was not possible during a “Data Control Time”, and

(1) if an Error_Action_Flag is set, then the operation mode changes from Operate to Clear;

(2) if the Error_Action_Flag is not set, the operation mode remains in Operate in case of an error;

(3) if the Error_Action_Flag is set, the operation mode is only changed from Clear to Operate if, in the Data Control Time, all slaves were in the user data exchange mode.

A minimum slave interval value can range from 0 to 6553500 ms and the default value is 125 ms. The minimum slave interval value specifies a smallest allowed period of time between two slave poll cycles. The minimum slave interval value should be greater than or equal to the Minimum Slave Interval parameter of a slowest slave connected to the FBM. This value should be smaller than or equal to any watch dog timeout of the slaves. A Data Control Time can range, for example, from 0 to 655350 ms and the default value is 150 ms. The data control time indicates the maximum time interval within which a valid exchange of process data has taken place between the master and a slave.

The bottom portion of FIG. 5 is associated with configurable bus parameters. A segment coupler field allows a user to select a configurable segment coupler (e.g., SK1, SK2, SK3, etc.) to automatically specify a set of default bus settings associated with the selected segment coupler. When the user selects the segment coupler, the available baud rates for the selected segment coupler are provided in the baud rate combo box. The user selects one of the baud rates and clicks on a Defaults button to get the default values. A Baud rate field enables a user to select a baud rate for the I/O module 110. Selecting the Optimize Timing button invokes a calculation of optimized timing values for the I/O module assembly 110 based upon a set of connected slaves. A validate button enables a user to invoke validating a current master and slave configuration.

A Max Retry Limit field enables a user to specify a maximum number of communication retries a master does before confirming a slave device to be failure. A GAP Update Factor provides the number of token rounds between GAP maintenance (update) cycles. GAP is the amount of time between tokens being passed on the bus. In the illustrative example the value is always 1.

A slot time field identifies a maximum time for the I/O module assembly 110 to wait for a transaction response. A Minimum Station Delay Response Time field specifies a value sent to connected devices to ensure the devices connected to the I/O module assembly do not reply too quickly. A Maximum Station Delay Response Time field specifies the time after which the responder must have processed a request and responded, if applicable. A Setup Time field specifies a time delay between an event (for example timer interrupted) and the necessary reaction (for example, enabling receiver). A Quit Time field specifies a time a transmitting station must wait after the end of a frame before enabling its receiver. A Target Rotation Time field specifies an anticipated time for one token round on the PROFIBUS network, including allowances for high and low priority transactions, errors and GAP maintenance.

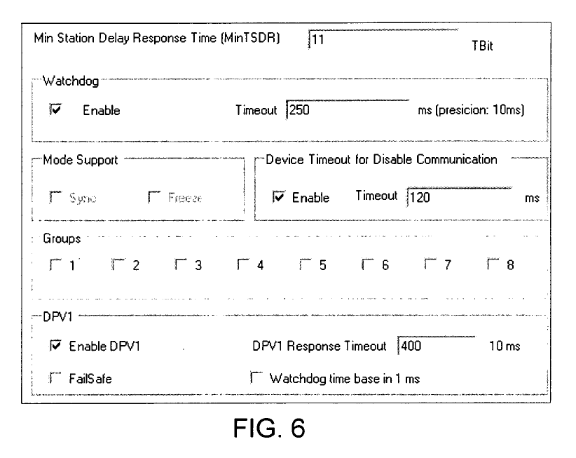

Profibus device bus parameters 420 provide a set of configurable bus parameters associated with Profibus devices that communicate with the I/O module assembly 110. In an exemplary embodiment, the Profibus device bus parameters 420 are specified via a graphical user interface depicted, by way of example, in FIG. 6. A Minimum station delay response time field specifies a minimum time to wait before generating a reply frame to the master. The default value for this field is 11 Tbit.

A Watchdog box includes an enabled field through which a user enables/disables a watchdog timer. An associated time out field holds a value specifying a watchdog timeout period.

A mode support box includes check boxes through which a user enables/disables specific global control functionality. The description of the check boxes present under this group is as follows:

Freeze (Check Box): allows specifying whether a slave will support Freeze mode. If the value of Freeze_Mode_Supp in the slave GSD (Profibus General Station Description) file is 0, then this check box is disabled. Otherwise, if the Freeze check box is checked, the slave supports the Freeze mode.

Sync (Check Box): allows specifying whether the slave will support Sync mode. If the value of Sync_Mode_Supp in the slave GSD file is 0, then the Sync check box is disabled. Otherwise, if the Sync check box is checked, the slave supports the Sync mode.

A Device Timeout for Disable Communication (Group Box) enables a user to specify how the Profibus device is treated when the communication to the Profibus device is broken. If Enable is checked, then the timeout value should be greater than 0 ms, if this timeout is defined a device equipment control block (e.g., ECB201) is set to “Disable Communication” when the communication to the device is broken for a duration larger than a timeout value specified in the Timeout field (e.g., 120 ms). Thus, if a device gets disconnected it is automatically set offline after the timeout. If Enable is not checked, then the Profibus device stays in an Enable Communication mode when communication is broken. The I/O module assembly 110 will try to set the Profibus device in online mode when it gets connected again.

A Groups box identifies a set of (8) selectable DPV1 groups.

A DPV1 box includes a set of fields associated with DPV1 functionality. An Enable DPV1 check box, when selected, specifies that a slave will use DPV1 functionality. A DPV1 Response Timeout field specifies a DPV1 response time out period. The default value for DPV1 response time is 4 sec (400 10 ms). A FailSafe check box enables a user to enable/disable a failsafe mode of operation for the Profibus device (slave). If checked the slave is operated in failsafe mode. In the failsafe mode the slave\ holds outputs at the last value received or sets outputs to a specified value in case of loss of communication. The user specifies the action of the slave outputs in a case of lost communication using device configuration tools. A watchdog time base check box changes the watchdog timeout base from 10 ms to 1 ms.

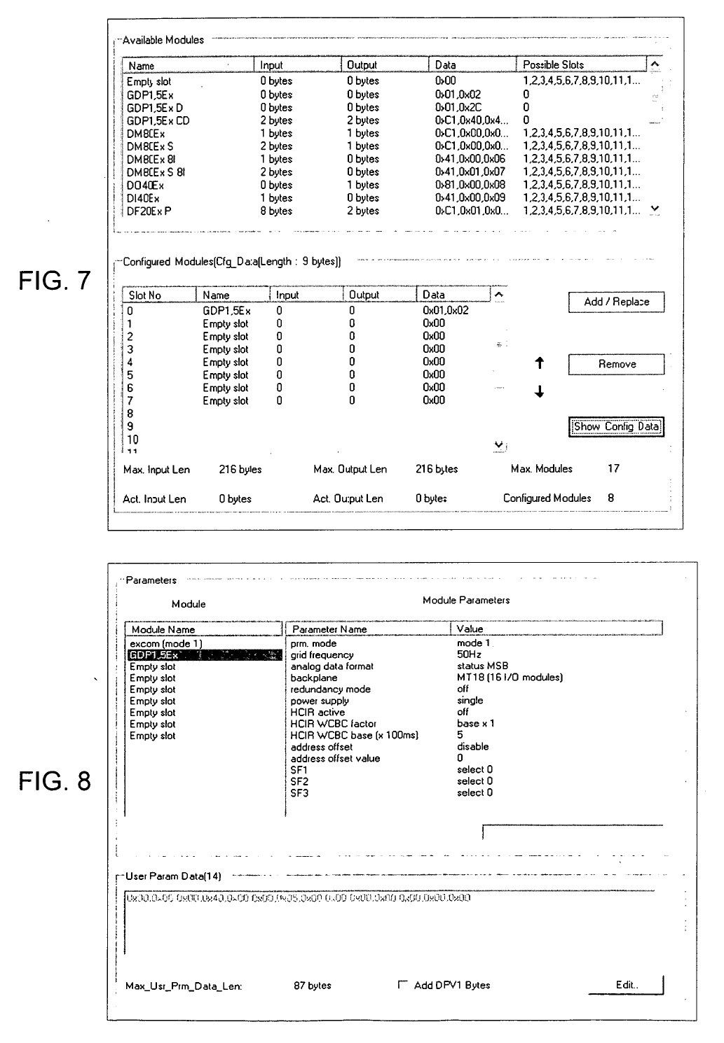

A module configuration 430 specifies a configuration of modules associated with connected Profibus devices and user parameters in the modules. The module configuration 430 is specified via a graphical user interface that displays a set of available modules and their associated parameters. In an exemplary embodiment (see, FIG. 7), a module configuration interface lists a set of “Available Modules” and “Configured Modules.” A user adds a module from the Available Modules to a particular slot in the Configured Modules by selecting a module under the Available Modules list, selecting a slot where the module is to be added, and clicking an Add/Replace button. A user replaces a module at a particular slot in the Configured modules by: selecting a module in the Available Modules list, selecting a module in the Configured Modules list which is to be replaced, and clicking the Add/Replace button. The existing module at the selected slot is replaced. A user removes modules from the Configured modules by: selecting the module(s) under the configured modules list and clicking a Remove button. Finally, a user swaps modules present at two slots by using up and down arrows on the user interface. To swap a module with another module at a slot above it, a user selects the module which needs to be swapped and clicks the Up arrow. To swap a module with another module at a slot below it, a user selects the module which needs to be swapped and clicks a Down arrow. Directly beneath the Configured modules listing, input/output lengths of slave data and Configured Modules are tallied (in the second line). The maximum numbers for the input/output length and modules are obtained automatically from the GSD file for the Profibus device.

A Show Config Data button opens up a new dialog that shows the configuration data bytes of the modules in a tree view in a grid. By default all modules are in a collapsed state. To view the configuration data bytes of a module, a user clicks on a symbol given in the first column of the grid. This dialog allows the user to view the data bytes in Binary, Hex and Decimal formats. The user changes the display from one format to another format by selecting a corresponding radio button.

A separate user parameters display (see, FIG. 8) comprises a list of text strings identifying particular parameters of a selected module and the current value. The user parameters display enables a user to view and modify parameters in selected modules. The selected modules are provided in the “Module” list wherein each module is identified by a Module Name text string. When a user selects one of the listed modules, the selected module's parameters are listed under a “Module Parameters” list. The “Module Parameters” list displays the name of the parameter (a text string) and its value (as an alphanumeric string). When a user clicks on any of the listed module parameters, available values for the selected parameter are provided in a combo box beneath the Module Parameters list or an edit control allows input of values.

A User Param Data box displays user parameter values of all configured modules. A Max_User_Prm_Data_Len field specifies a maximum number of user parameter data bytes supported by the device. If the Profibus device is a DPV1 device then an Add DPV1 Bytes checkbox is shown. The user can add or remove three bytes of user parameter data by checking or unchecking the DPV1 checkbox respectively. A user edits a current value for a parameter by selecting an Edit button that launches a “User Parameter Data” edit dialog. The User Parameter Data edit dialog shows the user parameter data for configured modules in a tree view. By default all modules are in a collapsed state in the tree. To view the user parameter data of a module, user clicks on a “+” symbol provided in a first column of the display. The User Parameter Data dialog enables a user to view and edit the data bytes in Binary, Hex and Decimal formats. User navigates from one data format to another format by selecting a corresponding radio button.

A Profibus device status mask 440 comprises a set of data fields specifying a status mask for a Profibus device connected to the I/O module assembly. The Profibus device status mask 440 includes a set of actions to be performed when particular statuses are sensed. In the exemplary embodiment, a byte is allocated for specifying an action associated with a particular potentially sensed status.

Profibus device configuration data 450 specifies configuration data for a Profibus device connected to the I/O module assembly 110. The Profibus device configuration data includes a file name of a file containing the configuration information for the Profibus device.

Having described exemplary I/O module assembly configuration structures/user interfaces for the I/O module assembly 110 coupled to one or more Profibus devices, attention is directed to a set of configurator user interfaces through which the I/O module assembly 110 is configured to interact with connected Profibus devices and respond to I/O (DCI) requests from the control module assembly 108. A data definition user interface enables a user to configure cyclic input and cyclic output parameters and messages. In accordance with an exemplary embodiment, the defined data definition parameters are associated with DCI blocks and thus their information is included in responses provided by the I/O module assembly 110 to the control module assembly 108.

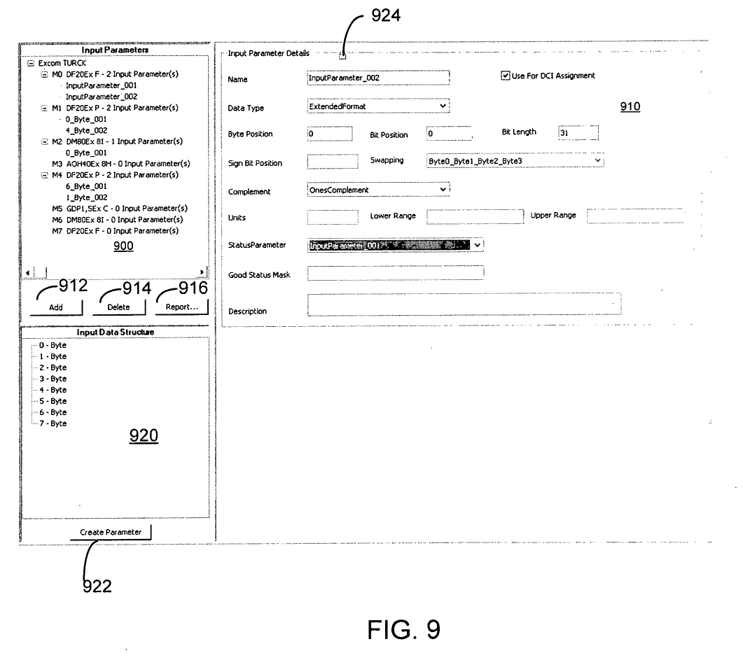

Turning to FIG. 9, an exemplary user interface for defining cyclic input parameters for a Profibus device is provided. The input parameter configuration user interface displayed in FIG. 9 includes an input parameters panel 900, an input parameter details panel 910, and an input data structure 920 that, in combination, enable a user to configure input parameters for Profibus device modules. If there are any already configured and saved input parameters at the time the input parameter configuration interface program is opened, those input parameters are displayed when the display screen is initially rendered.

Referring to the input parameters panel 900 of the illustrative input parameter configuration user interface of FIG. 9, the input parameters panel enumerates a set of defined input parameters of a Profibus device containing various modules as a hierarchically arranged tree view. More particularly, in the illustrative example, the input parameter configuration user interface of a configuration utility includes a root node specifying a Profibus device (e.g., Excom TURCK). The input parameters panel 900 lists, under the root node, a set of modules (e.g., M0, M1, etc.) corresponding to Profibus modules having available input data bytes. Input parameters defined by a user, such as InputParameter_{—}001 and InputParameter_{—}002 are displayed in a tree view under their associated module (M0). The parameters are user defined (from raw data bytes/bits supplied by the Profibus device). The module information specifies that it returns a specified stream of bytes (e.g., 8 bytes in the illustrative example). The user, through the Input Parameter Details panel 910 creates 2 parameters of type float to map into a designated set of 8 bytes returned by the module. The creation of parameters is by the user through an Add button 912 (described below). It is possible that the information provided by the device vendor in a GSD file provides sufficient information to create the parameters automatically (e.g., the vendor specifies that the module returns 2 floating point parameters for a total of 8 bytes).

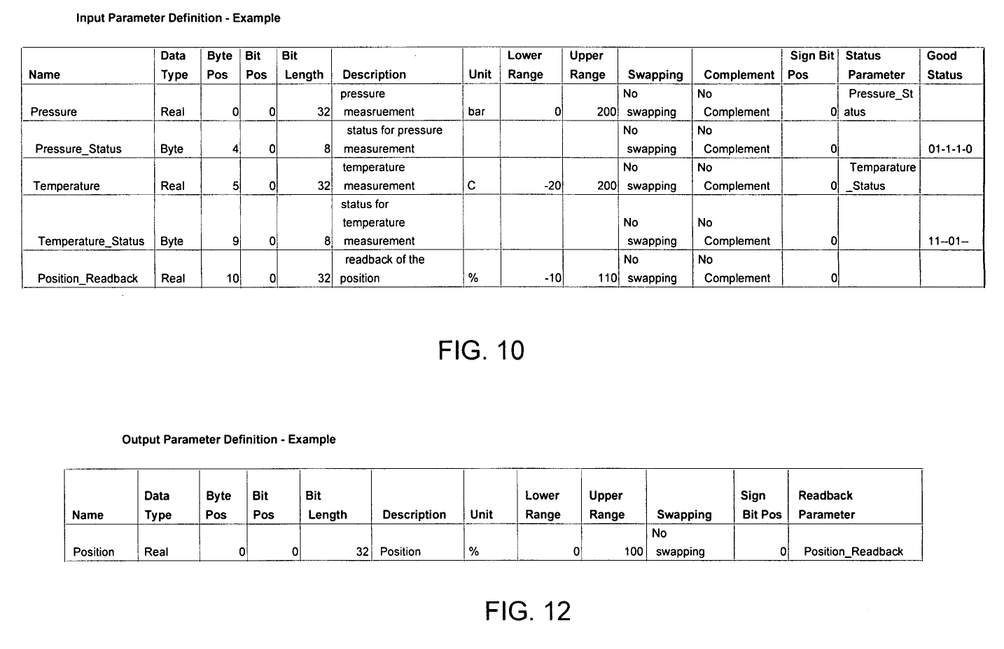

The input parameter details panel 910 displays a name, data type, byte position, bit position, bit length, description, units, lower range, upper range, swapping, complement, sign bit position, status parameter and good status fields for each input parameter. The details panel 910 also includes a “use for DCI assignment” checkbox. The “use for DCI assignment” checkbox, if selected, causes the input parameter definition to be used for DCI block association—an operation wherein DCI blocks are associated with the defined input parameters. Each of the remaining parameter details are described herein below with reference to FIG. 10, which comprises an exemplary “report view” of a set of defined input parameters and their associated configuration details. In an exemplary embodiment, when a user selects one of the input parameters enumerated in the input parameter panel 900, the input parameter configuration program populates the information fields within the parameter details panel 910 according to current values assigned to those fields for the selected input. parameter. Thereafter, the user edits the fields (to the extent permitted based upon the locked status of a parent). Changes to the selected input parameter are propagated to children of the edited input parameter according to the input parameter's locked status.

The add button 912 is associated with a procedure incorporated into the exemplary configuration program that enables a user to add a new input parameter to the input parameters represented in the tree view depicted in the input parameters panel 900 by selecting the add button 912. The add button 912, when selected, invokes a procedure for creating a new user defined parameter under a module identified in the tree structure presented in the input parameters panel 900. In an exemplary embodiment, the add button 912 is, for example, enabled when a user selects a module in the tree depicted in the input parameters panel 900. Thus, to add a new input parameter to a module, the user selects a module or an input byte within the module and clicks on the add button 912. The newly added parameter is created with a unique name, and an initial data type set to UnsignedInteger8. Adding a new parameter is performed by a user in cases where a module, according to a vendor's specification, can be broken down into individually defined parameters.

A delete button 914 is associated with a procedure incorporated into the exemplary configuration program that enables a user to delete an existing input parameter represented in the tree view depicted in the input parameters panel 900 by selecting the delete button 914. If a locked input parameter is deleted then the locked input parameter is deleted down the hierarchy. Otherwise, if a locked parameter is unlocked and deleted, then the deleted input parameter is locked in the next level templates and unlocked in the next level instances. The delete button 914 is disabled if no input parameter is selected, if the selected input parameter is extracted from a vendor-supplied device type manager (DTM), or if the selected input parameter is locked in a parent. A user cannot delete an input parameter at the instance level if it is associated to a deployed block(s). The exemplary input parameter configuration program will not permit a user to delete an input parameter at the template level if it is locked and any of the instances beneath it is associated with a deployed block(s).

The exemplary input parameter configuration interface also supports copying and pasting parameters. By way of example, a context menu is available on the input parameters panel 900 to copy and paste input parameters. User copies a selected input parameter using a copy menu item in the context menu. The copy menu item is disabled if a module is selected. A user pastes the copied parameter to a selected module using a paste menu item in the context menu. When user pastes the copied parameter a new parameter is created and added at the end of the input parameters listed under a selected module. The paste option is enabled when a module is selected.

A report button 916 is associated with a procedure for rendering a chart view depicting all the defined input parameters and their associated details. The view is sorted, by way of example, by byte position, bit position and bit length. An exemplary report view arrangement for input parameters is provided in FIG. 10 described herein below.

The input data structure panel 920 displays an input data structure for a selected module. In the illustrative embodiment, when a user selects a particular module (or input parameter within the module), a description of the data bytes contained within the selected module is provided in the input data structure panel 920. The exemplary configuration user interface for defining input parameters also supports adding an input parameter by clicking on a create parameter button 922. The create parameter button 922 is enabled when a user selects an input data type listed within the input data structure panel 920's tree view. When the create parameter button 922 is selected, a new input parameter is created with a unique name. Furthermore, when a new parameter is created by selecting the create parameter button 922, the byte position of the new parameter is the same as the relative byte position of the selected input data type and the selected data type is mapped to the parameter data type. Therefore if a vendor defines information about a selected module cyclic data structure, then that information is presented in the input data structure panel 920. For example, in panel 920 under Byte 0 an entry might identify the Byte 0 as an “integer” or “float” data type. The user can thereafter select the Byte 0 entry and press the create parameter button 922 to create a new defined parameter of the specified type and having the designated offset. If the vendor did not specify parameter information for the module, then panel 920 shows the byte stream for the module, and the Create button is disabled.

In an exemplary embodiment, templating of defined input parameters is supported. Moreover, the templating of input parameter configuration associated with the user interface depicted in FIG. 9 supports inheritance. Therefore a user can define an input parameter through the fields represented in the input parameter details panel 910, lock/unlock the definition using the lock icon 924, and thereafter save the defined input parameter as a template for use in defining other input parameters. The input parameter configuration will be propagated down a hierarchy of a set of defined templates in a configuration database and the children will have the ability to modify parameters of their parent templates based upon the lock status of the parent templates.

The lock icon 924 supports changing locked status of a currently selected input parameter by a user clicking on the lock icon 924. If the parameter is locked in the parent template or if the locking is not supported by the parameter then the lock icon is disabled.

The locking of an input parameter is supported only if a module containing the currently selected parameter is locked. Furthermore, locking an input parameter having a status parameter requires previously locking the associated status parameter. If a locked status parameter is unlocked then all the locked input parameters referring to the status parameter are unlocked. If an input parameter is locked in a parent template then users are not allowed to modify the input parameter. If a locked parameter is unlocked then the parameter is locked at the next level templates, and if a locked parameter is deleted then the deleted parameter is deleted from all derived templates and instances.

Referring to FIG. 10, an exemplary set of fields for defining input parameters (depicted previously in the details panel 910 in FIG. 9) is depicted along with an exemplary set of input parameter entries. A Name field is an editable string containing a user assigned name of an input parameter. A Data Type field specifies a type for the data (e.g., integer, Boolean, Floating point, Extended format, Packed bits, etc.). A Byte Position field specifies an editable starting byte position for the input parameter within the module. In the illustrative example the byte position is specified in a byte identifying a binary value between zero and 243. A Bit Position field, specifying a value between 0 and 7, is an editable field for entering a bit position within a byte from which the parameter definition starts. A Bit Length field is an editable field for entering a number of bits that are occupied by the input parameter.

A pair of fields of an input parameter enhances the understandability of the input parameter. A Description field specifies an editable string that describes the input parameter. A Units field specifies a particular set of units (e.g., degrees Celsius, meters, pounds, etc.) to be applied to the input value when rendered.

A lower range field specifies an editable value specifying a lowest value assignable to the input parameter. An upper range field specifies an editable value specifying a highest value assignable to the input parameter.

A next set of fields specifies manipulations to specified bytes of an input parameter. A swapping field includes a set of selectable options including: no swapping, or specified swapping for 2 bytes and 4 bytes. A complement field specifies either: no complement, 1's complement or 2's complement.

A sign bit position field contains an editable value specifying the location of a sign bit.

A status parameter field supports specifying an optional status parameter input value for determining the good/bad status of the specified input parameter. In the illustrative input parameter configuration user interface, the status parameter field for each listed input parameter is associated with a combo box control that presents a set of available input parameters from which a user designates a “status parameter” for the input parameter. Thus, for each input parameter for which a status parameter is designated, the DCI task 202 evaluates the associated status parameter and provides, in response to a DCI read request, both the requested input parameter value and the evaluated parameter status of the input parameter value. A timestamp representing when the particular input parameter data value was stored in the DCI repository 204 is also provided with each returned input parameter data value.

The timing of updates to the status of an input parameter varies in accordance with various illustrative embodiments. The DCI task 202 re-evaluates input parameter status without regard to whether a read request is pending for a particular input parameter. For example, the DCI task 202 re-evaluates an input parameter's status each time its primary value is updated in the repository 204. In an alternative embodiment, the parameter status (good/bad) is updated when a corresponding status parameter value changes. In yet another alternative embodiment, the DCI task 202 waits until a DCI read request is pending to re-evaluate the status of the input parameter. The latter update mode eliminates potential delays from re-evaluating statuses of each returned input parameter value and can be used in association with an alarm utility to expedite publishing alarms arising from bad input parameter statuses.

The content of the status information provided with an input parameter value differs in accordance with various exemplary embodiments. In a particular exemplary embodiment, the DCI task 202 returns either a “good” or “bad” parameter status value with each provided input parameter data value. By way of example, the DCI task 202 determines the good/bad status for an input parameter by applying a “Good Status” mask (see, e.g., “Good Status” column in FIG. 10), comprising a set of bits specifying “good” results for a set of input parameter data quality tests, to a set of actual input parameter data quality test results specified by the contents of a designated status parameter.

By way of example, a configured Good Status mask comprises a string of “0”, “1” and “−” (don't care) characters. The values represented by these characters are applied to corresponding bit positions of the specified status parameter for the input parameter. In an illustrative example, the “1” and “0” characters specified in the Good Status mask are compared to the current values of corresponding bit positions in the specified status parameter. “Don't care” bit positions are skipped in the status parameter during the comparison. If, upon completing the comparison of bit positions where either a 1 or 0 was specified in the Good Status mask, all bit values match, then a “good status” value is attached by the DCI task 202 to the parameter data value returned to the control module assembly 108 for the particular input parameter.

A wide variety of forms of parameter status information are potentially conveyed with input parameter values provided by the DCI task 202 when updating input parameters for the control module assembly 108. For example, while the above-described illustrative embodiment attaches a simple “good”/“bad” status value to each input parameter (based upon one or more underlying tests—any one of which could render a “bad” status), in alternative embodiments more descriptive status values are provided with the input parameter value. For example, rather than merely providing a good/bad designation, the status value provided with the input parameter value comprises a set of error codes corresponding to each failed test.

Furthermore, a variety of test schemes, represented in the illustrative example by the individual bits of a status parameter, are contemplated. For example, in a particular embodiment, a standard set of tests are represented by corresponding bit positions of a status parameter byte associated with a particular status parameter. In the illustrative example the following tests are associated with an assigned bit position in the status byte:

1: Parameter Value is Bad

2: Parameter Value is Unavailable (Out of service)

3: Parameter Value is Questionable

4: Parameter Value Source is Disconnected

5: Parameter Value Out of prescribed range high

6: Parameter Value Out of prescribed range low

However, in alternative embodiments, the set of tests associated with the individual bits are customizable and vary according to, for example, the type of input parameter or a class of input parameters.

For each input parameter, user can select the data type, swapping, complement, status parameter from the available values in a combo box. The combo boxes are not editable. The user is provided with the option of deleting a defined parameter.

Attention is now directed to configuration of output parameters. Turning to FIG. 11, an exemplary user interface for defining cyclic output parameters for a Profibus device is provided. The output parameter configuration user interface displayed in FIG. 11 includes an output parameters panel 1100, an output parameter details panel 1110, and an output data structure 1120 that, in combination, enable a user to configure output parameters for Profibus device modules. If there are any already configured and saved output parameters at the time the output parameter configuration interface program is opened, those output parameters are displayed when the display screen is initially rendered.

Referring to the output parameters panel 1100 of the illustrative output parameter configuration user interface of FIG. 11, the output parameters panel enumerates a set of defined output parameters of a Profibus device containing various modules as a hierarchically arranged tree view. More particularly, in the illustrative example, the output parameter configuration user interface of a configuration utility includes a root node specifying a Profibus device (e.g., Excom TURCK). The output parameters panel 1100 lists, under the root node, a set of modules (e.g., M0, M1, etc.) corresponding to Profibus modules having available output data bytes. Output parameters, such as OutputParameter_{—}001, are displayed in a tree view under their associated module (e.g., M0). The parameters are user defined (from raw data bytes/bits supplied by the Profibus device). The module information specifies a stream of bytes (e.g., 8 bytes in the illustrative example). The user, through the Output Parameter Details panel 1110 creates 2 parameters of type float to map into a designated set of 8 bytes in the module. The creation of parameters is by the user through an Add button 1112 (described below). It is possible that the information provided by the device vendor in a GSD file provides sufficient information to create the parameters automatically (e.g., the vendor specifies that the module contains 2 floating point parameters for a total of 8 bytes).

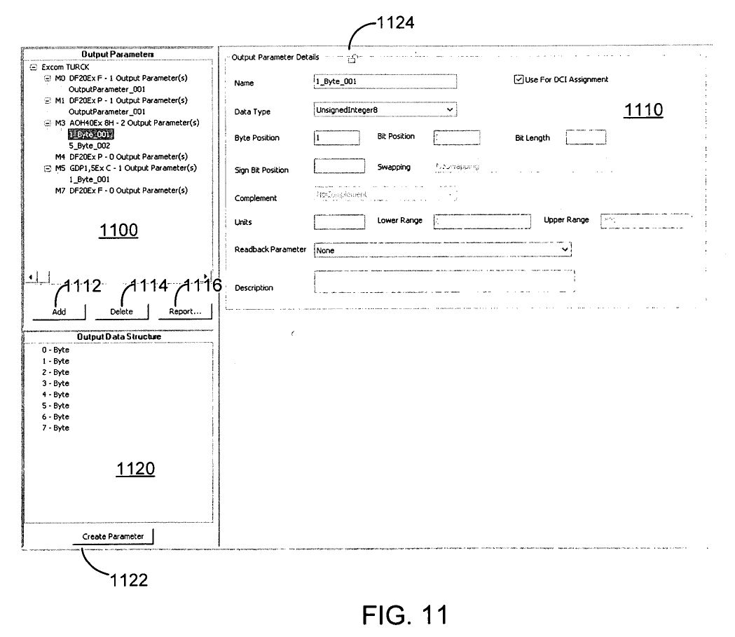

The output parameter details panel 1110 displays a name, data type, byte position, bit position, bit length, description, units, lower range, upper range, swapping, complement, sign bit position, and readback parameter for each output parameter. The details panel 1110 also includes a “use for DCI assignment” checkbox. The “use for DCI assignment” checkbox, if selected, causes the output parameter definition to be used for DCI block association—an operation wherein DCI blocks are associated with the defined output parameters. The remaining parameter details are described herein below with reference to FIG. 12, which comprises an exemplary “report view” of a set of defined output parameters and their associated configuration details. In an exemplary embodiment, when a user selects one of the output parameters enumerated in the output parameter panel 1100, the output parameter configuration program populates the information fields within the parameter details panel 1110 according to current values assigned to those fields for the selected output parameter. Thereafter, the user edits the fields (to the extent permitted based upon the locked status of a parent). Changes to the selected output parameter are propagated to children of the edited output parameter according to the output parameter's locked status.

The add button 1112 is associated with a procedure incorporated into the exemplary configuration program that enables a user to add a new output parameter to the output parameters represented in the tree view depicted in the output parameters panel 1100 by selecting the add button 1112. The add button 1112, when selected, invokes a procedure for creating a new user defined parameter under a module identified in the tree structure presented in the output parameters panel 1100. In an exemplary embodiment, the add button 1112 is, for example, enabled when a user selects a module in the tree depicted in the output parameters panel 1100. Thus, to add a new output parameter to a module, the user selects a module or an output byte within the module and clicks on the add button 1112. The newly added parameter is created with a unique name, and an initial data type set to Unsignedlnteger8. Adding a new parameter is performed by a user in cases where a module, according to a vendor's specification, can be broken down into individually defined parameters.

A delete button 1114 is associated with a procedure incorporated into the exemplary configuration program that enables a user to delete an existing output parameter represented in the tree view depicted in the output parameters panel 1100 by selecting the delete button 1114. If a locked output parameter is deleted then the locked output parameter is deleted down the hierarchy. Otherwise, if a locked parameter is unlocked and deleted, then the deleted output parameter is locked in the next level templates and unlocked in the next level instances. The delete button 1114 is disabled if no output parameter is selected, if the selected output parameter is extracted from a vendor-supplied device type manager (DTM), or if the selected output parameter is locked in a parent. A user cannot delete an output parameter at the instance level if it is associated to a deployed block(s). The exemplary output parameter configuration program will not permit a user to delete an output parameter at the template level if it is locked and any of the instances beneath it is associated with a deployed block(s).

The exemplary output parameter configuration interface also supports copying and pasting parameters. By way of example, a context menu is available on the output parameters panel 1100 to copy and paste output parameters. User copies a selected output parameter using a copy menu item in the context menu. The copy menu item is disabled if a module is selected. A user pastes the copied parameter to a selected module using a paste menu item in the context menu. When user pastes the copied parameter a new parameter is created and added at the end of the output parameters listed under a selected module. The paste option is enabled when a module is selected.

A report button 1116 is associated with a procedure for rendering a chart view depicting all the defined output parameters and their associated details. The view is sorted, by way of example, by byte position, bit position and bit length. An exemplary report view arrangement for output parameters is provided in FIG. 12 described herein below.

The output data structure panel 1120 displays an output data structure for a selected module. In the illustrative embodiment, when a user selects a particular module (or output parameter within the module), a description of the data bytes contained within the selected module is provided in the output data structure panel 1120. The exemplary configuration user interface for output parameter also supports adding an output parameter by clicking on a create parameter button 1122. The create parameter button 1122 is enabled when a user selects an output data type listed within the output data structure panel 1120's tree view. When the create parameter button 1122 is selected, a new output parameter is created with a unique name. Furthermore, when a new parameter is created by selecting the create parameter button 1122, the byte position of the new parameter is the same as the relative byte position of the selected output data type and the selected data type is mapped to the parameter data type.

Therefore if a vendor defines information about a selected module cyclic data structure, then that information is presented in the output data structure panel 1120. For example, in panel 1120 under Byte 0 an entry might identify the Byte 0 as an “integer” or “float” data type. The user can thereafter select the Byte 0 entry and press the create parameter button 1122 to create a new defined parameter of the specified type and having the designated offset. If the vendor did not specify parameter information for the module, then panel 920 shows the byte stream for the module, and the Create button is disabled.

In an exemplary embodiment, templating of defined output parameters is supported. Moreover, the templating of output parameter configuration associated with the user interface depicted in FIG. 11 supports inheritance. Therefore a user can define an output parameter through the fields represented in the output parameter details panel 1110, lock/unlock the definition using the lock icon 1124, and thereafter save the defined output parameter as a template for use in defining other output parameters. The output parameter configuration will be propagated down a hierarchy of a set of defined templates in a configuration database and the children will have the ability to modify parameters of their parent templates based upon the lock status of the parent templates.

The lock icon 1124 supports changing locked status of a currently selected output parameter by a user clicking on the lock icon 1124. If the parameter is locked in the parent template or if the locking is not supported by the parameter then the lock icon is disabled.

The locking of an output parameter is supported only if a module containing the currently selected parameter is locked. Furthermore, locking an output parameter having a status parameter requires previously locking the associated status parameter. If a locked status parameter is unlocked then all the locked output parameters referring to the status parameter are unlocked. If an output parameter is locked in a parent template then users are not allowed to modify the output parameter. If a locked parameter is unlocked then the parameter is locked at the next level templates, and if a locked parameter is deleted then the deleted parameter is deleted from all derived templates and instances.

Referring to FIG. 12, an exemplary set of fields for defining output parameters (depicted previously in the details panel 1110 in FIG. 11) is depicted along with an exemplary set of output parameter entries. A Name field is an editable string containing a user assigned name of an output parameter. A Data Type field specifies a type for the data (e.g., integer, Boolean, Floating point, Extended format, Packed bits, etc.). A Byte Position field specifies an editable starting byte position for the output parameter within the module. In the illustrative example the byte position is specified in a byte identifying a binary value between zero and 243. A Bit Position field, specifying a value between 0 and 7, is an editable field for entering a bit position within a byte from which the parameter definition starts. A Bit Length field is an editable field for entering a number of bits that are occupied by the output parameter.

A pair of fields of an output parameter enhances the understandability of the output parameter to a user. A Description field specifies an editable string that describes the output parameter. A Units field specifies a particular set of units (e.g., degrees Celsius, meters, pounds, etc.) to be applied to the output value when rendered.

A lower range field specifies an editable value specifying a lowest value assignable to the output parameter. An upper range field specifies an editable value specifying a highest value assignable to the output parameter.

A next set of fields specifies manipulations to specified bytes of an output parameter. A swapping field includes a set of selectable options including: no swapping, or specified swapping for 2 bytes and 4 bytes. A complement field specifies either: no complement, 1's complement or 2's complement.

A sign bit position field contains an editable value specifying the location of a sign bit.

A Read Back parameter field is associated with a combo box that presents a set of available Input parameters from which a user designates a “Read back” parameter. The Read back parameter field thus enables a user to choose an optional input parameter that is associated with the output parameter value. In an exemplary embodiment, the data repository 204 includes both an output field (storing an output parameter value to be written to a Profibus device) and a read back field (storing an input parameter value read from the Profibus device). The read back field can specify an actual current value for a specified input parameter or, alternatively, a “reference” to the input parameter (the designated read back parameter for the output parameter). Thus, for example, a valve position output parameter can specify an associated read back/input parameter that provides the currently registered position of the valve positioner. In an exemplary embodiment, during runtime the read back field for an output parameter is updated in the repository 204 with the current value of the specified read back input parameter value. The read back value for an output parameter is returned to the control module assembly 108 in response to a read request that references the read back field of the output parameter. The ability to specify a read back parameter facilitates easier identification of an input parameter representing the effect of a specified output parameter value from a control loop programming point of view since the association between input and read back parameters is specified during the configuration of an I/O module assembly 110 for a Profibus device.

For each output parameter, a user selects the data type, swapping, complement, and read back parameter from the available values in a combo box. These combo boxes are not editable. A user is permitted to edit the values of rest of the fields. The user is provided with the option of deleting a defined parameter.

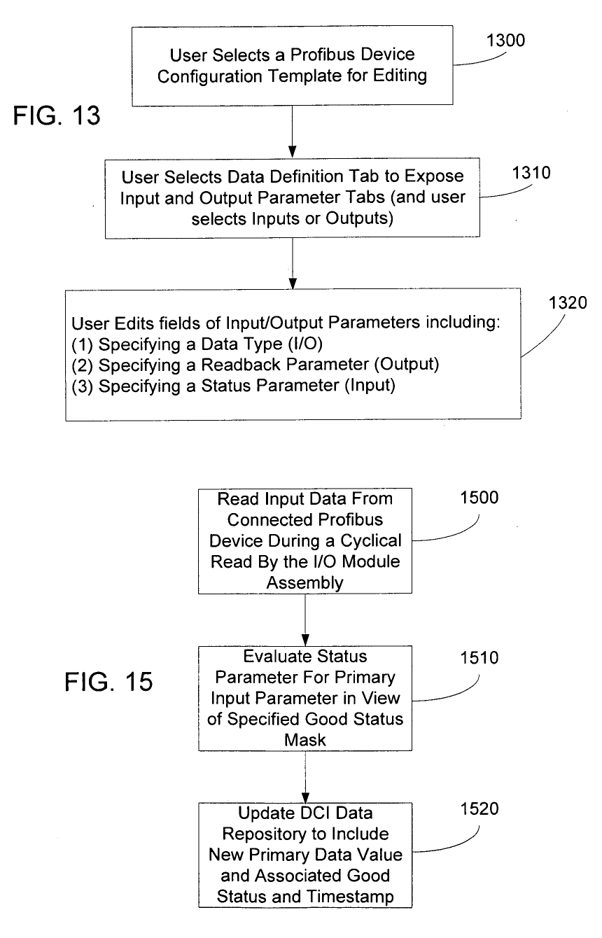

Turning to FIG. 13, an exemplary set of steps are summarized for defining the Input and Output parameters of a Profibus device previously discussed herein above with reference to FIGS. 9-12. The Profibus device I/O parameters are exposed to, and used by, a control program executed by the control module assembly 108. The parameter values are passed between the I/O module assembly 110 and the control module assembly 108 via DCI blocks defined for the Profibus device. Therefore, after defining a set of I/O parameters, the user maps the I/O parameters to DCI blocks executed in the control module assembly 108.

Initially, during step 1300, a user selects a Profibus device (template or instance) and the corresponding configuration file is accessed by the workstation 102's configurator application. During step 1310 Data Definition tab is selected to provide access to a set of selectable tabs for accessing Input and Output parameters associated with the selected Profibus device. During step 1320 fields (e.g., name and attribute fields) of existing entries and/or entire entries are modified in one or both of the Input Parameters and the Output Parameters lists are edited. During step 1320 the following user-directed operations are potentially performed to specify the name and attributes for an I/O parameter:

(1) a user navigates input or output data in a separate list that displays the module borders and the number of bytes within a module for a Profibus device.

(2) the user is supported in defining the data type. For example, by “right clicking” in the data type field, a context menu opens to specify the data type. The selected data type and the bit length are entered for the parameter and are read-only if the data type (e.g. Real) is well defined.

(3) the user is supported in defining a readback (read-back) parameter of an output parameter. As explained previously herein above, the readback field for an output parameter specifies an input parameter from which the value of the output parameter is specified. A user accesses the potential input parameters from which a readback parameter is specified by right clicking in the readback field. Thereafter, a list is displayed showing the choices of input parameters that can be designated as the readback parameter for the output parameter.

(4) the user is supported in defining a status parameter (see, “Status Parameter” field in FIG. 10 described herein above) associated with an input parameter. As explained previously herein above, the status parameter is evaluated in association with an input data value and represents the status of the input parameter data. In an exemplary embodiment, a user accesses the potential status parameters by right clicking in the status field, and a list is displayed showing the possible choices of Input parameters from which the status parameter is selected. In addition to selecting an input parameter, the user also defines a status bit mask for verifying good status (see, “Good Status” in FIG. 10) for the status parameter.

Separately, via a control program editor utility, a user creates a process control program executable on the control module assembly 108. The control program includes DCI blocks for writing/reading data to/from a Profibus device via the I/O module assembly 110.

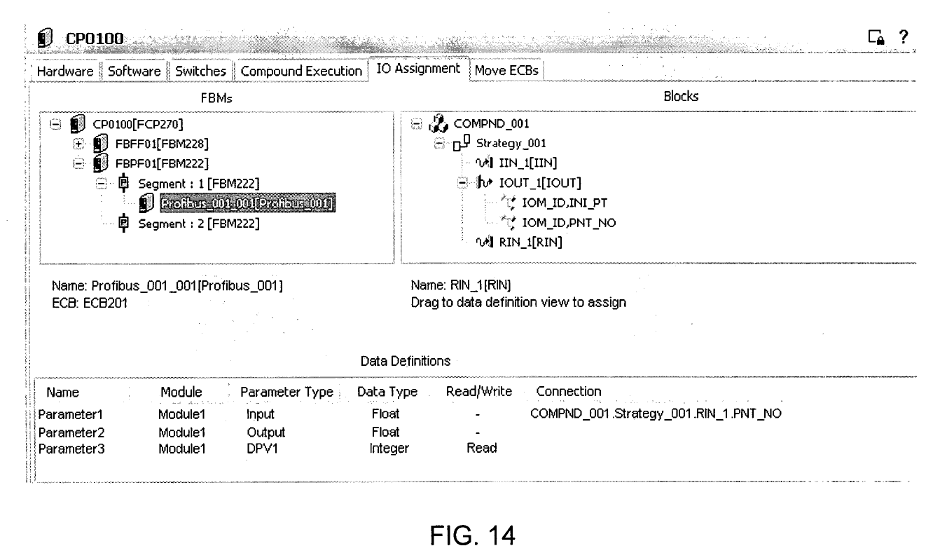

Furthermore, in an exemplary embodiment, a data connections utility having a user interface depicted, by way of example in FIG. 14, facilitates assigning DCI blocks to particular ones of the input/output parameters defined via the Profibus device input/output configuration user interfaces described herein above with reference to FIGS. 9-12. After a configuration has been downloaded to the I/O module assembly 110, the connections defined via the data connection editor interface depicted in FIG. 14, tie DCI blocks on the control module assembly 108 to corresponding Profibus device I/O parameters maintained in the DCI repository 204 of the I/O module assembly 110.

A user selects a Profibus device from the FBM configuration tree depicted in the top-left corner of the illustrative user interface. Thereafter, a set of input and output parameters configured for the selected Profibus device are depicted in the “Data Definitions” section of the user interface. A user creates a connection by simply selecting a DCI block from the “Blocks” section in the top-right corner of the user interface, and dropping the selected block on a particular row in the “Data Definitions” section. It is noted that only one DCI block can be connected to an output parameter listed in the “Data Definitions”. However, multiple DCI blocks can share a single input parameter. Thus, dropping a DCI block on an input parameter for which a DCI block was previously assigned results in the creation of a second row identifying the same input parameter. The created connection is incorporated into the configuration definitions maintained within the DCI repository 204 for later use by the DCI task 202 when carrying out DCI requests on behalf of the control module assembly 108.

Having described exemplary runtime arrangements and configuration operations, attention is directed to FIG. 15 that summarizes a set of steps performed by the I/O module assembly 110 in response to a parameter read operation for an input parameter having an associated status parameter (and “good status” mask). It is noted that while the present example is provided for a single input parameter, such read operations are generally carried out with regard to a set of input parameters provided by the I/O module assembly 110 to the control module assembly 108.

Initially, during step 1500, a set of input values are read by the I/O module assembly 110. By way of example, the I/O data scan task 218 maintains a local version of the cyclic scan list for the I/O module assembly 110 to read I/O data from Profibus devices. Thereafter, in response to notification of completion of the input data scan during step 1500 (wherein values are updated for a primary input parameter as well as a status parameter associated with the primary input parameter), during step 1510 the I/O data scan task 218 processes the current value of the associated status parameter in view of a good data mask specified by the primary input parameter to render a good/bad status value for the primary input parameter. During step 1520, the I/O data scan task 218 updates DCI connection records in the DCI data repository 204 corresponding to the primary input parameter. By way of example, for primary input parameters having a defined input status value parameter, the I/O data scan task 218 evaluates the associated status parameter byte for an input primary value parameter and updates a corresponding DCI block data item in the DCI data repository 204 to include a current primary input value, a good/bad status, and a time stamp. The stored primary input value and associated good/bad status are thereafter provided to a control module assembly 108 in response to a read request. In an exemplary embodiment, the DCI read does not require any separate read operation to obtain both the primary input value and its associated good/bad status.

### Diagnostic Data Handling

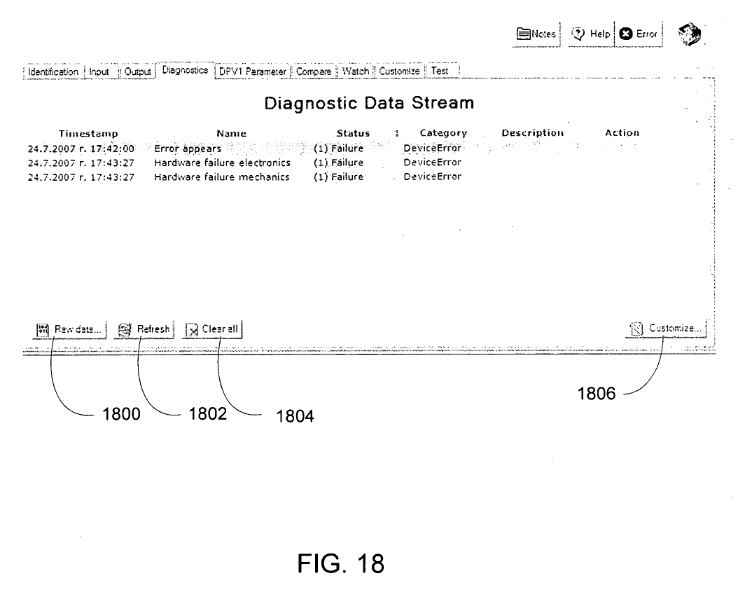

In accordance with an exemplary embodiment, a Profibus diagnostic data configurator program, comprising computer executable instructions stored on computer-readable media, is executed on the workstation 102 (or any other appropriate computing device(s)) to support configuring a user interface program to display meaningful, text-based Profibus device diagnostic messages and parameter values. The diagnostic messages and parameter values are rendered from binary diagnostic data bits provided by Profibus devices to the I/O module assembly 110. In the exemplary embodiment, the defined diagnostic messages and parameter values are rendered in displays rendered by a Profibus universal device type manager (UDTM) application program. An example of such a display is provided herein below with reference to FIG. 18. However, the configured diagnostic messages and parameters can be utilized in a variety of runtime system configuration, tuning, monitoring, and control applications.

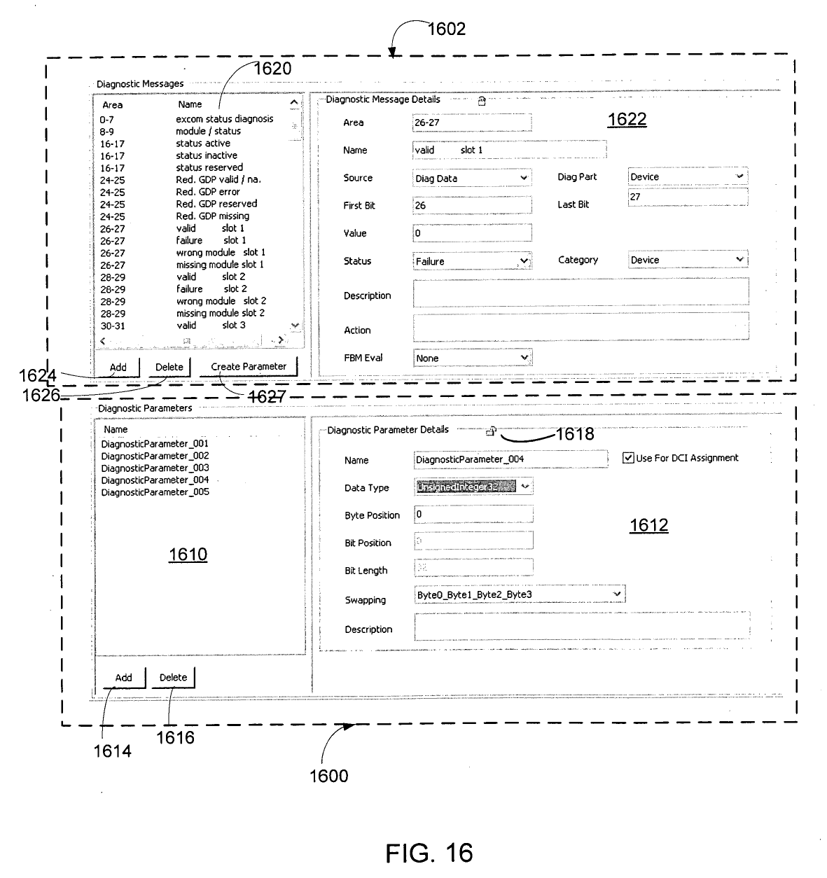

Turning to FIG. 16, an exemplary user interface is provided of a Profibus diagnostic data configurator program. The exemplary user interface comprises list and input boxes for defining diagnostic parameters (name, data type, byte position, bit position, bit length, swapping, and description) and diagnostic messages (area, name, source, diagnostic part, first bit, last bit, value, status, category, description, action and FBM evaluation) for a Profibus device. The provided sets of data for diagnostic parameters and messages is exemplary as those skilled in the art will appreciate that the types of information defining diagnostic data and associated messages need not be limited to the sets described herein.

The diagnostics configuration user interface displayed in FIG. 16 includes two group boxes. A diagnostic parameters group box 1600 displays a listing of user defined diagnostic parameters associated with parts of the Profibus device diagnostic message or device parameters. In the illustrative example, the diagnostic parameters are associated with DCI blocks. A diagnostic messages group box 1602 displays a user-extendable/definable set of message entries including additional descriptive information associated with a set of diagnostic data bits contained within a Profibus device message received by the I/O module assembly 110.

The location of program modules that process the set of diagnostic data bits to render messages and parameter values, according to a specified configuration, differs in accordance with alternative exemplary embodiments. In a particular embodiment, the raw diagnostic data bits are passed from the I/O module assembly 110 to the workstation 102 via the control module assembly 108. However, in an alternative embodiment, the configured diagnostic message and parameter processing tasks are downloaded to the I/O module assembly 110 which applies the configured diagnostic message and parameter definitions to received raw diagnostic data to render diagnostic messages and parameter values that are initially passed to the control module assembly 108. The control module assembly 108 thereafter forwards the diagnostic message to a system monitor application running on a workstation such as workstation 102 which displays diagnostic information in the form of diagnostic text-based messages.

The diagnostic parameters group box 1600 provides a user interface for configuring diagnostic parameters for display in a diagnostic tab of a system monitor application program. In the exemplary embodiment the parameters group box 1600 includes a diagnostic parameter list view panel 1610. The diagnostic parameter list view panel 1610 displays a list of configured diagnostic parameters for a previously selected Profibus device. The parameters group box 1600 also includes a diagnostic parameter definition panel 1612 comprising a set of input box controls facilitating user-specified modifications to a parameter selected from the list view panel 1610.

The diagnostic parameters group box 1600 supports creating new diagnostic parameter definitions for a selected Profibus device. Such functionality is invoked by a user clicking on an Add button 1614 provided, by way of example, below the diagnostic parameter list view panel 1610. When a new parameter is created the configuration program automatically assigns a default unique name, a data type set to UnsignedInteger8, and an unlocked status (for propagation of changes).

The diagnostic parameters group box 1600 supports deleting an existing diagnostic parameter definition from the set of parameters enumerated in the parameter list view panel 1610. Such functionality is invoked by a user clicking on a Delete button 1616 after selecting one of the parameters in the parameter list view panel 1610. If a locked parameter is deleted then all children in a derivation hierarchy will have the same parameter deleted. If a locked parameter is unlocked and then deleted, then the diagnostic parameter has a locked status in the next lower level templates and unlocked in the next lower level instances. The delete button 1616 functionality is disabled if no diagnostic parameter is selected, or if the selected parameter is locked in a parent. Also, a user will not be allowed to delete a diagnostic parameter at the instance level if it is associated with a deployed block(s). In the illustrative embodiment, a user is not allowed to delete a diagnostic parameter at the template level if the diagnostic parameter template is locked and at any of the instances beneath the diagnostic parameter is associated with a deployed block(s).

In operation, when a user selects a diagnostic parameter, the diagnostic parameter definition panel 1612 displays a set of details (described herein below) associated with the selected parameter. Each of the identified data entry fields in the diagnostic parameters definition panel 1612 corresponds to a field in a data structure element (e.g., configuration database record) maintained for each configured diagnostic parameter listed in the diagnostic parameter list view panel 1610.

A lock icon 1618 in the diagnostic parameter definition panel 1612 displays a current lock status of a selected parameter. In an exemplary embodiment, clicking on the lock icon toggles the lock status of the currently selected diagnostic parameter. If the parameter is locked in a parent template or if locking is not supported by the parameter then the lock icon status will not respond to clicking on the lock icon. The parameter definition panel 1612 supports user modifications to the various properties of a selected diagnostic parameter (subject to locked status). The selected diagnostic parameter is edited via the displayed edit boxes in the parameter definition panel 1612. Modifying a property of a selected parameter is disabled if the parameter/property is locked in a parent. When a locked parameter is modified, all changes are propagated down the hierarchy. Each of the displayed diagnostic parameter fields is described herein below.

With continued reference to the diagnostic parameter definition panel 1612 generated by the computer-executable instructions of the Profibus diagnostic data configuration program, a Name field stores an editable string containing a user assigned name of a diagnostic parameter. A Use For DCI Assignment check box corresponds to a Boolean value indicating whether the specified parameter name is used for DCI block association. The user cannot uncheck the checkbox if the parameter is already associated with a DCI block.

A data type field specifies a type for the diagnostic parameter. In the exemplary embodiment the choice of data type is limited via a combo box control that enumerates available data types from which a user can select. In an exemplary embodiment choices include: signed 8-bit integer, signed 16-bit integer, signed 24-bit integer, signed 32-bit integer, unsigned 8-bit integer, unsigned 16-bit integer, unsigned 24-bit integer, unsigned 32-bit integer, extended format, packed bits, Boolean, floating point, Channel Bit, and raw. This listing of data types differs in alternative embodiments.

A byte position field specifies an editable starting byte position for the diagnostic parameter within a Profibus device message. In the illustrative example the byte position is specified in a byte identifying a binary value between zero and 243.

A Bit Position field, specifying a value between 0 and 7, is an editable field for entering a bit position within a byte from which the diagnostic parameter definition starts. A Bit Length field, specifying a value between 1 and 256, is an editable field for entering a number of bits that are occupied by the diagnostic parameter.

A swapping field is a combo box providing a selectable swapping type for the currently selected diagnostic parameter. In the exemplary embodiment the list of selectable swapping types (showing the result of a swapping action) includes: no swapping, Byte0_Byte1, Byte0_Byte1_Byte2, Byte0_Byte1_Byte2_Byte3, Byte2_Byte3_Byte0_Byte1, and Byte1_Byte0_Byte3_Byte2. Other Byte swapping modes are contemplated in alternative embodiments.

A Description field specifies an editable string that describes the diagnostic parameter.

In an exemplary embodiment, when a user finishes modifying a selected diagnostic parameter and tries to move out of the diagnostic parameter definition panel 1612 the fields of the edited parameter are validated by the configuration program, if there are any validations errors a message box is generated that contains error information, and focus is placed on a field which caused the validation error.

The following are exemplary validations on diagnostic parameter definitions when a user attempts to move out of a diagnostic tab page of the configuration program.

1. A diagnostic parameter shall not be defined beyond 244 bytes.

2. If the data type of the diagnostic parameter is extended format or packed bits, then the bit length must range from 1 to 32-bit positions.

3. The selected swapping option should be compatible with the bit length of the diagnostic parameter.

With continued reference to FIG. 16, the diagnostic messages group box 1602 enables a user to configure diagnostic messages, and to create diagnostic parameters from the configured diagnostic messages, for a Profibus device for display in a diagnostic tab of a system monitor application program (or any other desired configuration, tuning, monitoring, controlling, etc. application program). In the exemplary embodiment the diagnostic messages group box 1602 includes a diagnostic messages list view panel 1620. The diagnostic messages list view panel 1620 displays a list of configured diagnostic messages for a previously selected Profibus device. The messages group box 1602 also includes a diagnostic message definition panel 1622 comprising a set of input box controls facilitating user-specified modifications to a diagnostic message definition selected from the diagnostic messages list view panel 1620.

In an exemplary embodiment, the Profibus diagnostic data configurator program includes computer-executable instructions for extracting diagnostic message definitions from a GSD file, and the extracted diagnostic message definitions are enumerated in the diagnostic messages list view panel 1620.

The diagnostic messages group box 1602 supports creating new diagnostic message definitions for a Profibus device. Such functionality is invoked by a user clicking on an Add button 1624 provided, by way of example, below the diagnostic message list view panel 1620. When a new message is created the configuration program automatically assigns a default unique name, an unlocked status (for propagation of changes), and the new message is added to the list in the list view panel 1620.

The diagnostic messages group box 1602 supports deleting an existing diagnostic message definition from the set of diagnostic messages enumerated in the message list view panel 1620. Such functionality is invoked by a user clicking on a Delete button 1626 after selecting one of the messages in the diagnostic messages list view panel 1620. If a locked message is deleted then all children in a derivation hierarchy will have the same message deleted. If a locked message is unlocked and then deleted, then the diagnostic message has a locked status in the next lower level templates and unlocked in the next lower level instances. The delete button 1626 functionality is disabled if no configured diagnostic message is selected, or if the selected diagnostic message is locked in a parent.

In the illustrative embodiment of the diagnostic message configuration program interface, a control is provided to enable users to create a diagnostic parameter from diagnostic message by selecting a particular listed diagnostic message from the diagnostic messages list view panel 1620 and then clicking on a Create Parameter button 1627 provided below the diagnostic messages list view panel 1620. The Create Parameter button 1627 is disabled if no message is selected or the selected message is invalid.

The configuration program generates a number of the fields automatically for the new diagnostic parameter. The newly created parameter is provided with a name and a description from the selected diagnostic message. If a diagnostic parameter already exists with this name, then a unique name is generated. A byte position is set to an offset of the message (first bit/8), a bit position is set to a first bit of message % 8, and bit length is set to last bit—first bit+1 of the message. If the message is defined with in a single bit, then the data type of the message is set to ChannelBit. Otherwise the data type is set to PackedBits. The newly created diagnostic parameter is added to the diagnostic parameters list view panel 1610 within the diagnostic parameters group box 1600 and is selected in the diagnostic parameters list view (to cause the aforementioned field values to be displayed in the parameter definition panel 1612.

### EXAMPLE 1

Message: name=“Invalid Slot”, description=“”, first bit=28, last bit=29

Create Parameter: name=“Invalid Slot”, description=“”, data type PackedBits,

byte position=3, bit position=4 and bit length=2.

### EXAMPLE 2

Message: name=“Status Active”, description=“”, first bit=16, last bit=16

Create Parameter: name=“Status Active”, description=“”, data type=ChannelBit,

byte position=2, bit position=0 and bit length=1.

In operation, when a user selects a diagnostic message in the diagnostic messages list view panel 1620, the diagnostic messages definition panel 1622 displays a set of details (described herein below) associated with the selected diagnostic message. Each of the identified data entry fields in the diagnostic messages definition panel 1622 corresponds to a field in a data structure element (e.g., configuration database record) maintained for each configured diagnostic message listed in the diagnostic messages list view panel 1620.

A lock icon 1628 displays the lock status of the selected diagnostic message. A user changes the lock status of the diagnostic message by clicking on the lock icon 1628. If the message is locked in the parent template or if locking is not supported by the message, then the lock icon is disabled. In an exemplary embodiment locking a diagnostic message with a DPV1 parameter as its source is allowed only if the DPV1 parameter is locked. Locking a diagnostic message with a module selected in a Diag Part field of the diagnostic message definition panel 1622 is allowed only if at least one instance of this module is locked.

Some of the involved objects for which inheritance is supported have a contained-in relationship (e.g. the modules may contain user parameters, input, output and diagnostic parameter and diagnostic messages). For such objects the following inheritance rules are defined:

1: It is only possible to lock contained objects if the container (e.g. module) is locked.

2: If the container is unlocked all the contained objects are unlocked.

Some of the involved objects for which inheritance is supported have a reference relationship (e.g. an input parameter may reference another parameter as status parameter). For such a relationship the following inheritance rule is defined:

1: If a locked parameter references another parameter, then the referenced parameter must be locked first. If this restriction was not imposed, it would be possible to change important parts (e.g. status) of a locked parameter, which would not get propagated to the derived objects.

The above rule results in the following behavior:

1: In a locked parameter it is not possible to create a reference to an unlocked parameter.

2: If a locked parameter is unlocked, then all references in other locked parameters are cleared/deleted.

If the source DPV1 parameter is unlocked or if all instances of a module are unlocked, then all the locked diagnostic messages referring to the parameter/module will be unlocked. If a locked diagnostic message is unlocked then this message shall be locked at the next level templates.

With continued reference to the diagnostic messages definition panel 1622 generated by the computer-executable instructions of the Profibus diagnostic data configuration program, an Area field stores a string value that describes an area in a diagnostic data bit sequence from which the diagnostic data bits are taken. In an exemplary embodiment the diagnostic message bit area is specified as “FirstBitPosition—Last Bit Position”. Therefore, if a diagnostic message is associated with a bit sequence beginning with bit 0 and ending with bit 3, then the Area would be “0-3”.

A Name field includes a string that specifies a name for a diagnostic message.

A Source field comprises a combo box control from which a user specifies a string identifying a source for the diagnostic message from an enumerated set of potential sources. In an exemplary embodiment the source of a diagnostic message can be a GSD file (Diag Data) or a parameter defined in a DPV1 screen (DPV1 parameter name).

A Diag Part field comprises a combo box control from which a user selects a string specifying a device, device channel, or configured module name for diagnostic messages specifying “Diag Data” in the source field (it is otherwise disabled). If the diagnostic message is defined for a Profibus device, then the value is “Device.” If the message is defined for a device channel, then the value is “Device Channel.” If the diagnostic message is defined for a specific module then the value in the Diag Part field is the module's name.

A First Bit field byte data has a value between zero and 495. The First Bit field specifies a starting bit of the diagnostic message data driving the particular defined diagnostic message. A Last Bit field specifies a last bit of the diagnostic message data.

A Value field stores byte data having a value between 0 and 65535. When the received bit sequence specified by the first-to-last bit range (see First Bit and Last Bit fields described above) evaluates to the value stored in the value field, the particular diagnostic message is set (issued).

A Status field, by way of example, is a combo box control for specifying a configurable diagnostic message string. The status field defines a diagnostic status message string associated with the value specified in the Value field of the diagnostic message entry in the diagnostic messages. Examples of diagnostic message strings include: OK, Out of Specification, Maintenance Request, and Failure.

A Category field, by way of example, is a combo box control for specifying a configurable string indicating a type of error associated with the diagnostic message. Examples of error categories, selectable from a drop down list include “Process”, “Communication”, and “Device” error types.

A Description field facilitates specifying a string that provides a brief description/help message that provides further description to the diagnostic message.

An Action field facilitates specifying a string constituting an instruction to a user to take an action when the diagnostic message is activated/generated for display to the user.

An FBM Evaluation field, by way of example, is a combo box control that specifies a set of selectable strings specifying the severity of an error associated with the diagnostic message. Potential values for the string are “Error”, “Warning”, or none. If Error or Warning is selected, the I/O module assembly 110 (e.g., FBM222) uses the diagnostic data for device status evaluation.

### Use of Templates in Configuration of Advanced Diagnostics

In accordance with an exemplary embodiment, the above-described advanced diagnostics configuration data for Profibus device modules is maintained, in the configuration/design environment, as a template. Each template is potentially derived from a parent template and is potentially a parent to a derived child template. The Profibus device module configurations are arranged and displayed in a hierarchical (expandable) tree structure displayed in a template toolbox window of the configuration host application. In an exemplary embodiment, the child templates inherit the definitions provided by parent templates. Thus, a set of application-specific Profibus device module definitions are potentially derived from more generally defined templates. Changes to parent templates are propagated to child templates.

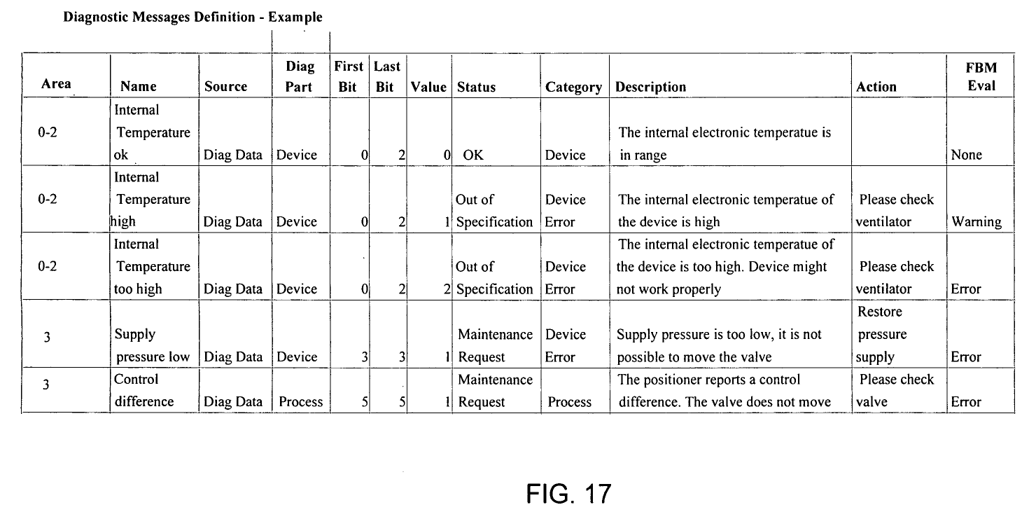

Turning briefly to FIG. 17, an exemplary set of configured diagnostic messages are provided. The top row identifies the “fields” of the diagnostic message definition panel 1622, and each of the five remaining rows specifies a configured diagnostic message. The configured diagnostic messages, in essence, facilitate automated processing and rendering of meaningful messages from otherwise non-descript diagnostic data bit values provided by Profibus devices. For example, rather than merely providing a binary value or sequence of values indicating a diagnostic status, a system monitor driven by the defined diagnostic message definitions potentially: renders a text string warning, a description of the warning's significance, an action to be taken to address the warning, and a severity level associated with the diagnostic status.

In an exemplary embodiment the configured diagnostic messages for a Profibus device are stored as a GSD file. The contents of the GSD file are thereafter extracted by a Profibus UDTM user application to define the operation of a diagnostic messages tab control driven by diagnostic data bits provided by the Profibus device.

The descriptive diagnostic information discussed herein above, with reference to FIGS. 16 and 17, is presented via any of a variety of diagnostic data monitoring user interfaces. Turning to FIG. 18 an exemplary integrated host application user interface is depicted. In the exemplary embodiment, diagnostic messages are extracted from a GSD file. The defined diagnostic messages and parameter values are rendered in displays driven by a Profibus universal device type manager (UDTM) application program. The illustrative example user interface includes diagnostic messages rendered from binary diagnostic data bits provided by Profibus devices to the I/O module assembly 110 in accordance with a previously specified configuration (see, FIGS. 16 and 17).

In the illustrative embodiment in FIG. 18, each diagnostic message potentially includes the following: a timestamp, a name, a status, a category, a description (of the message), and a potential action to be taken. The timestamp indicates when a displayed diagnostic message was received. In an exemplary embodiment, a diagnostic message is added to the list depicted in the user interface by the interface program only when a new diagnostic message is reported. Thus, if a diagnostic message is re-sent at a later time for a previously received diagnostic message that is already displayed, then only the timestamp field is updated for the particular diagnostic message record. A name field corresponds to a name assigned to a diagnostic message definition (i.e., a descriptive name identifying a device status associated with the message). As shown in FIG. 18, names are generally short phrases (e.g., “Hardware Failure Electronics”) describing a status for a Profibus device entity. A status field provides the descriptive status text associated with the value (if available) as it was previously defined in the diagnostic message definition (see, FIGS. 16 and 17). A category field provides text describing a message category as it was previously defined in the diagnostic message definition (see, FIGS. 16 and 17). A description field provides a description of the diagnostic message (an extension of the descriptive “Name” field for the diagnostic message). An action field provides a recommended action description—or alternatively provides an instruction that is used by the system to automatically address a current diagnostic status corresponding to the diagnostic message.

In the illustrative example, a raw data button 1800 is provided to enable users to access the actual raw diagnostic data bits that drive diagnostic messages listed under the “Diagnostic Data Stream” heading in FIG. 18. In an exemplary embodiment, any received raw diagnostic data bits are stored by the Profibus UDTM application. A refresh button 1802 enables a user to force an unscheduled refresh of diagnostic data bits that drive the displayed diagnostic message list. A clear all button 1804 enables a user to clear a current listing of diagnostic messages.

A customize button 1806 is associated with a dialog for configuring the operating characteristics of the diagnostic messages interface. In an exemplary embodiment the customize button 1806 launches a dialog enabling a user to modify the refresh time period for the Profibus UDTM requesting updated diagnostic data bits. Through the customization button dialog a user also modifies the number of messages kept in the list of diagnostic message queue (with the oldest being purged to accommodate new diagnostic messages). Such purging only affects the user interface. The underlying diagnostic data bits are maintained separately by, for example, the I/O module assembly 110 (e.g., in the DCI repository 204) within the process control system.

In an alternative embodiment, the user interface depicted in FIG. 18 also includes a listing of parameter value names and values that correspond to the diagnostic data bits.

Turning to FIG. 19, a flowchart summarizes an exemplary set of steps for defining/configuring and thereafter saving diagnostic messages for a Profibus device template. In accordance with an exemplary embodiment, the entries of the diagnostic messages include additional content/information (described herein above with reference to FIGS. 16 and 17). A set of diagnostic messages for a Profibus device is edited via a diagnostic messages user interface of the type depicted in FIG. 16. Initially, during step 1900 a user selects a Profibus device template from a template toolbox tree (not shown). In response, at step 1910 a Profibus device editor application retrieves and displays configuration information associated with the selected Profibus device template. During step 1920 a user selects a “Diagnostics” tab on the editor application user interface to expose a diagnostic messages grid of the type depicted in FIG. 16.

Thereafter, during a diagnostic messages editing session at step 1930, a user edits the currently displayed set of diagnostic message entries. The editing functions include: editing an existing entry (e.g., specify an Action string), adding a new entry (specifying a name, bit/range, value, status, category, and description), copying/pasting an existing entry and editing one of the replicated entries to create a new diagnostic message, and deleting an entry. A user saves the Profibus device template during step 1940. In an exemplary embodiment the diagnostic messages are stored in, for example, a configuration database maintained on the workstation 102 for later access by a Profibus UDTM application executed on the workstation 102.

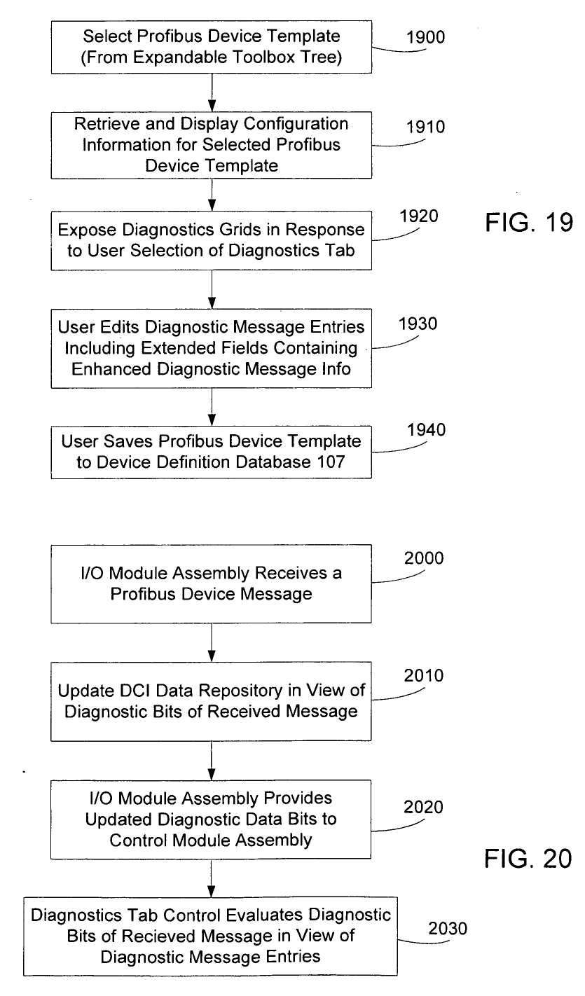

Turning to FIG. 20, a set of steps summarize the runtime use of diagnostic messages contained in deployed Profibus device configurations (based on the previously defined Profibus device configuration templates). In an exemplary embodiment, a user selects a Profibus device instance on a system monitor to cause the display of status information for equipment associated with the Profibus device. The diagnostic information is obtained for display on the system monitor interface by the following summarized methodology. During step 2000 the I/O module assembly 10 receives a Profibus device message containing diagnostic data bits.

During step 2010 the I/O module assembly 10 updates the content of the DCI data repository 204 based upon the content of the received Profibus device message.

Thereafter, during step 2020 the updated diagnostic messages are provided by the I/O module assembly 110 to the control module assembly 108 in accordance with executed DCI blocks. The diagnostic messages include the diagnostic data bits.

Thereafter, during an evaluation step 2030, the diagnostics tab control of the Profibus UDTM running on the Workstation 102 applies a previously defined set of diagnostics message entries (see, e.g., FIGS. 16 and 17) to the diagnostic data bits. In accordance with the illustrative embodiment, the diagnostics tab control extracts particular bits from the Profibus device message based upon the content of a bit sequence specified by a first and last bit field in a diagnostic message entry. The extracted diagnostic bit sequence value is then compared to the content of the Value field of the diagnostic message entry. If the values match, then the diagnostic message “fires” and an appropriate diagnostic message is generated and displayed on the diagnostics tab control user interface. See, FIG. 18.

The content of the displayed diagnostic messages rendered via the system monitor user interface is potentially any of the fields defined for each diagnostic message (see, e.g., FIGS. 16 and 17) including text strings specifying: a name assigned to the message, a status (e.g. “OK”), a description, and a recommended action. Furthermore, the system monitor user interface may assign a visual characteristic (e.g., a color—white/healthy, yellow/warning, and red/failed) to a Profibus device node in a hardware view to reflect a current status of the Profibus device or it attached equipment. This is yet another example of the simultaneous display of data and status with regard to a Profibus device.

In the above example, the diagnostic message information is presented on a configuration/commissioning application (i.e., a Profibus UDTM). However, the diagnostic message information is alternatively acquired and presented by a system runtime monitor application (i.e., as live data).

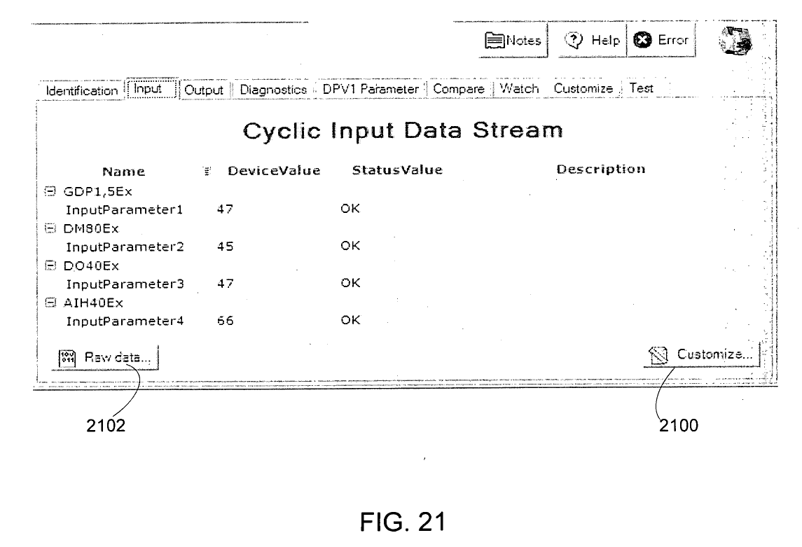

Turning to FIG. 21, an exemplary user interface is presented for an input parameter tab incorporated into a Profibus device configuration/commissioning application. In an exemplary embodiment, an input parameter tab control module, when placed in an on scan mode of operation, periodically updates the cyclic input parameter values (including parameter status) for display via the exemplary user interface. A similar interface is provided for displaying cyclic output parameter values—in that case a read back value is also potentially updated instead of a status parameter.

When accessed initially by a user, the input parameter tab control lists all input (output) parameters defined previously via a configuration interface. If a user thereafter adds new parameters through the configuration interface, the interface depicted in FIG. 21 will not automatically add the parameters to the display. Instead, a user adds the newly defined parameters manually through a customization dialog launched when a user selects a customize button 2100.

In an exemplary embodiment, the customize dialog provides a listing of all configured parameters. The listing of potentially displayable parameters is presented alongside a list of presently displayed parameters. In an exemplary embodiment the customization dialog also incorporates parameter filters enabling a user to reduce the size of the list of potentially displayable parameters by designating a particular filter/category of input parameters. In an exemplary embodiment a variety of filter types are supported including: predefined groups, user-defined groups, and Profibus device modules. Furthermore, the exemplary customize dialog provides an editable box enabling a user to designate (in seconds) the refresh/update period for the values displayed in the input parameter value display interface depicted in FIG. 21.

In an exemplary embodiment, customized input/output data displays are potentially saved as templates and incorporate the inheritance features discussed previously herein above with regard to input and output parameter configuration (see, FIGS. 9 and 11). Therefore a user can define a cyclical input (output) data display screen using the aforementioned customization dialog, lock/unlock the definition using a lock icon, and thereafter save the defined cyclic input (output) display screen as a template for use in defining other input (output) display screens. The cyclic data display configuration will be propagated down a hierarchy of a set of defined templates in a configuration database and the children will have the conditional ability to modify parameters of their parent templates based upon the lock status of the parent templates. If the cyclic data display definition is locked in the parent template then the lock icon is disabled.

In the illustrative example, a raw data button 2102 is associated with an executable procedure that displays actual raw parameter data corresponding to the parameter values displayed via the interface depicted, by way of example, in FIG. 21.

With continued reference to FIG. 21, the input (output) parameters are grouped by module. Thus, the following information is displayed for the displayed parameters in accordance with an exemplary embodiment: a module name, a parameter name, a parameter value, a status, and a parameter description.

In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that some elements of the illustrated embodiments shown in software, stored on, for example, physical (e.g., a hard disk, removable disc, a thumb drive, etc.) computer-readable media (or alternatively a non-physical computer readable media) in the form of computer executable instructions, may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A method for providing enhanced user access to Profibus device diagnostic data in a distributed control system wherein a Profibus device is communicatively coupled via a network link to an I/O module assembly, wherein the I/O module assembly receives Profibus device messages from the Profibus device containing information relating to connected device modules, and wherein the I/O module assembly includes one or more tasks for extracting and processing information contained within the received Profibus device messages according to a Profibus device configuration, the method comprising:
processing in accordance with the Profibus device configuration, a Profibus device message by performing the additional steps of:
extracting diagnostic data bits from the Profibus device message according to diagnostic parameter configuration entries in the Profibus device configuration, and
depositing the diagnostic data bits in an I/O data repository on the I/O module assembly;
receiving, by a diagnostic data monitoring user interface application, the diagnostic data bits; and
generating, by the diagnostic data monitoring user interface application, a set of diagnostic text messages based upon the diagnostic data bits by applying a set of configured diagnostic message definitions to the diagnostic data bits.

2. The method of claim 1 further comprising displaying the set of diagnostic text messages in the form of timestamped message entries on a graphical user interface rendered by the diagnostic data monitoring user interface application.

3. The method of claim 1 further comprising displaying the set of diagnostic text messages in the form of multi-segmented message entries within a multi-columned diagnostic text message display.

4. The method of claim 3 wherein the multi-segmented message entries include a name field, and the generating step comprises providing a name for a diagnostic message entry of the set of diagnostic text messages.

5. The method of claim 3 wherein the multi-segmented message entries include a status field, and the generating step comprises providing a status for a diagnostic message entry of the set of diagnostic text messages.

6. The method of claim 3 wherein the multi-segmented message entries include a category field, and the generating step comprises providing a category for a diagnostic message entry of the set of diagnostic text messages.

7. The method of claim 3 wherein the multi-segmented message entries include a description field, and the generating step comprises providing a text-based description explaining the meaning of received diagnostic data bits corresponding to a diagnostic message entry of the set of diagnostic text messages.

8. The method of claim 3 wherein the multi-segmented message entries include an action field, and the generating step comprises providing a text-based action description explaining an action to be taken in view of a diagnostic status represented by the received diagnostic data bits corresponding to a diagnostic message entry of the set of diagnostic text messages.

9. The method of claim 8 wherein the action comprises an executable command invoking a computer instruction sequence addressing a diagnostic status represented by the received diagnostic data bits.

10. The method of claim 3 wherein the multi-segmented message entries include a timestamp field, and the generating step comprises providing a timestamp for a diagnostic message entry of the set of diagnostic text messages.

11. A system for providing enhanced user access to Profibus device diagnostic data in a distributed control system, the system comprising:
a Profibus device;
an I/O module assembly communicatively coupled to the Profibus device via a network link, wherein the I/O module assembly receives Profibus device messages from the Profibus device containing information relating to connected device modules, and wherein the I/O module assembly includes a computer-readable medium having computer-executable instructions for extracting and processing information contained within the received Profibus device messages according to a Profibus device configuration, the information including diagnostic data bits; and
a workstation adapted to receive the diagnostic data bits, the workstation including:
a diagnostic data monitoring user interface application program, and
a configurable set of diagnostic message definitions for the Profibus device, and wherein the diagnostic data monitoring user interface application program includes computer-executable instructions for generating a set of diagnostic text messages, based upon current values of the diagnostic data bits representing diagnostic statuses of the Profibus device, by applying the configurable set of diagnostic message definitions to the diagnostic data bits.

12. The system of claim 11 wherein the diagnostic data monitoring user interface application program includes computer-executable instructions for displaying the set of diagnostic text messages in the form of timestamped message entries on a graphical user interface rendered by the diagnostic data monitoring user interface application.

13. The system of claim 11 wherein the diagnostic data monitoring user interface application program includes computer-executable instructions for displaying the set of diagnostic text messages in the form of multi-segmented message entries within a multi-columned diagnostic text message display.

14. The system of claim 13 wherein the multi-segmented message entries include a name field, and the computer-executable instructions for generating a set of diagnostic text messages provide a name for a diagnostic message entry of the set of diagnostic text messages.

15. The system of claim 13 wherein the multi-segmented message entries include a status field, and the computer-executable instructions for generating a set of diagnostic text messages provide a status for a diagnostic message entry of the set of diagnostic text messages.

16. The system of claim 13 wherein the multi-segmented message entries include a category field, and the computer-executable instructions for generating a set of diagnostic text messages provide a category for a diagnostic message entry of the set of diagnostic text messages.

17. The system of claim 13 wherein the multi-segmented message entries include a description field, and the computer-executable instructions for generating a set of diagnostic text messages provide a text-based description explaining the meaning of received diagnostic data bits corresponding to a diagnostic message entry of the set of diagnostic text messages.

18. The system of claim 13 wherein the multi-segmented message entries include an action field, and the computer-executable instructions for generating a set of diagnostic text messages provide a text-based action explaining an action to be taken in view of a diagnostic status represented by the received diagnostic data bits corresponding to a diagnostic message entry of the set of diagnostic text messages.

19. The system of claim 18 wherein the action comprises an executable command invoking a computer instruction sequence addressing a diagnostic status represented by the received diagnostic data bits.

20. The system of claim 13 wherein the multi-segmented message entries include a timestamp field, and the computer-executable instructions for generating a set of diagnostic text messages provide a timestamp for a diagnostic message entry of the set of diagnostic text messages.
